(19) United States
(12) Patent Application Publication
(10) Pub. No.: US 2025/0162449 A1
(43) Pub. Date: May 22, 2025

(54) SYSTEMS AND METHODS FOR ELECTRIC MOTOR VEHICLE CHARGING RECOMMENDATIONS AND FEATURES

(71) Applicants: Michael N. Gell, Charlotte, NC (US); Patrick L. Kartes, Charlotte, NC (US)

(72) Inventors: Michael N. Gell, Charlotte, NC (US); Patrick L. Kartes, Charlotte, NC (US)

(21) Appl. No.: 18/839,042

(22) PCT Filed: Feb. 21, 2023
(86) PCT No.: PCT/US2023/013487

§ 371 Date: Aug. 16, 2024

Related U.S. Application Data
(60) Provisional application No. 63/314,696, filed on Feb. 28, 2022.

(51) Int. Cl. B60L 58/12; B60W 20/12

(52) U.S. Cl. CPC B60L 58/12; B60W 20/12; B60L 2240/68; B60L 2240/72; B60L 2250/16; B60L 2260/52; B60L 2260/54

(57) ABSTRACT

Systems, methods, and computer program products for providing recommendations and features related to charging of batteries for electrically powered motor vehicles are provided herein. Various systems and methods utilize current motor vehicle data and/or user preference data to determine recommended charge devices for a user as they travel, removing the need to research/plan out charge device options during travel and the worry of running out of charge. Various systems and methods provide tailored recommendations and features that help a user select which charge device to use and provide options to occupy the user while the charging occurs. Additionally, relevant offers or promotions for nearby accommodations are provided herein. Various systems and methods also recommend turning off certain devices to elongate the estimated travel distance. Desirable maps for aiding in travel planning and visualizing where the current amount of charge will reach are also provided herein.

### CROSS-REFERENCE TO RELATED APPLICATION(S)

This international application claims priority to U.S. Provisional Application No. 63/314,696, entitled “Systems and Methods for Electric Motor Vehicle Charging Recommendations and Features”, filed Feb. 28, 2022; the contents of which is incorporated by reference herein in its entirety.

### TECHNOLOGICAL FIELD

Example embodiments of the present invention relate generally to charging electric vehicle batteries and, more particularly, relate to methods and systems for providing recommendations and features related to electric vehicle battery charging.

### BACKGROUND

Electrically powered motor vehicles have gained popularity, particularly in view of their positive environmental impact. However, current infrastructure for roadways is based on providing fuel in the form of, for example, gas or diesel for motor vehicles—as gas stations are plentiful. Moreover, fuel can be pumped to fill up a gas tank of a motor vehicle relatively quickly, with tanks often filling up completely within 5 minutes or less.

Currently, electrically powered motor vehicles have limited travel distance range per full battery charge (e.g., often 300 miles or less). Of further concern for potential electrically powered motor vehicle owners is that there is limited infrastructure along the roadways, leaving worry that on long trips the motor vehicle may run out of charge and leave the riders stranded. Moreover, current charge options often take 4+ hours to fully charge a battery of an electrically powered motor vehicle, making it undesirable to recharge the battery away from the user's home or work. These factors severely limit widespread adoption of electrically powered motor vehicles and likely prevent potential buyers from purchasing such motor vehicles.

### BRIEF SUMMARY

Notably, current charge device software applications are limited in functionality and are difficult to use. In this regard, there are no recommendation features that take into account various important factors, including, for example, data corresponding to the actual motor vehicle with the battery that needs to be recharged. Further, there is no accounting of user preferences including, for example, various activities that the user can do during charge periods that are significantly longer than fill up times for gas tanks.

Embodiments of the present invention provide methods and systems that attempt to alleviate the concerns of users of electrically powered motor vehicles and provide various recommendations and features to aid the user in, for example, finding charge devices, selecting charge devices, finding desirable activities to do while the battery is charging, trip planning, and general operation of electrically powered motor vehicles. In this regard, in some embodiments, various factors and data are applied to provide tailored recommendations and features. Some example factors include current vehicle data (e.g., current charge remaining in the battery, current usage of various devices of the motor vehicle, etc.), current position data associated with the current location of the motor vehicle, charge device data corresponding to various charge devices (e.g., their location, charge speed, availability, etc.), nearby accommodation data (e.g., nearby restaurants, parks, coffee shops, etc.), user preference data (e.g., user preferences for charge devices, accommodations, charge device features, etc.), among other things, such as detailed herein. Different weights and/or priorities can be applied to the factors. Such recommendations and features may be dynamically updated as the motor vehicle travels, providing real time relevant recommendations and features which may, for example, save the user from the worry of having to research which charge device to use as they drive.

In some embodiments, the system may provide recommendations regarding how long to use a charge device. Such a recommendation may correspond to various factors or circumstances, such as an estimated needed amount of charge to complete a trip or an estimated amount of time a user would spend at an accommodation associated with the charge device to maximize the user's experience.

In some embodiments, offers or promotions for accommodations nearby a charge device may be determined and provided to encourage a user to utilize a charge device. The offers or promotions may be determined per user based on user preferences.

In some embodiments, trip planning is provided that accounts for available charge devices and also takes into account various factors. For example, the trip planning can factor in whether there is a charge device at a route's destination when planning where and when to recommend/plan usage of one or more charge devices.

In some embodiments, various map overlays may be provided to help a user visualize where they can travel based on their current charge remaining in their battery. This will help a user “see” where their battery charge will allow them to travel to. The map overlay can be dynamically updated, and recommendations can be provided to help increase where the user can reach on their current charge remaining in their battery.

While some embodiments are contemplated for fully electrically powered motor vehicles, many of the recommendations and features described herein are beneficial for hybrid motor vehicles that utilize electrically powered engines and fuel (e.g., gas, diesel) powered engines.

Accordingly, such beneficial recommendations and features help alleviate concerns of the user while driving an electrically powered motor vehicle and aim to improve the overall user experience. As such, example embodiments of the present invention can be useful in bridging the gap of infrastructure for electrically powered motor vehicles and help incentive further use of the electrically powered motor vehicles (and further building of infrastructure for all electrically powered motor vehicles).

In an example embodiment, a system for recommending a charge device for an electric powered motor vehicle is provided. The system comprises a motor vehicle comprising an engine for propelling the motor vehicle on land using electrical energy, a battery for providing the electrical energy to the engine, wherein the battery is rechargeable, and a battery sensor configured to sense an amount of charge remaining in the battery. The system further includes memory and a processor configured, when executing computer program product code stored in the memory, to receive current motor vehicle data, wherein the current motor vehicle data includes at least charge remaining data, and wherein the charge remaining data corresponds to a current amount of charge remaining in the battery. The processor is further configured to determine a current location of the motor vehicle; and receive current charge device data corresponding to a plurality of charge devices, wherein each of the plurality of charge devices is capable of recharging at least a portion of the battery of the motor vehicle, wherein the current charge device data includes at least (i) a location corresponding to each of the plurality of charge devices and (ii) a current or projected availability status to recharge the battery of the motor vehicle of each of the plurality of charge devices, and wherein the projected availability status of a charge device corresponds to availability of the charge device at an estimated time when the motor vehicle would be estimated to arrive at the location of the charge device. The processor is further configured to determine a recommended one of the plurality of charge devices for recharging the battery of the motor vehicle based on at least the following: (i) the current location, (ii) the current motor vehicle data including the charge remaining data, and (iii) the current charge device data including the location of the recommended one of the plurality of charge devices and the current or projected availability status of the recommended one of the plurality of charge devices. The processor is further configured to cause the determined recommended one of the plurality of charge devices to be presented on a user interface to a user corresponding to the motor vehicle, wherein presentation of the recommended one of the plurality of charge devices includes an indication of the location of the recommended one of the plurality of charge devices and the current or projected availability status of the recommended one of the plurality of charge devices.

In some embodiments, the processor is further configured to receive current roadway data, wherein the current roadway data includes at least current traffic or construction data for one or more roadways. The processor is further configured to determine the recommended one of the plurality of charge devices further based on the current roadway data including the current traffic or construction data corresponding to one or more routes that lead from the current location to the location of the recommended one of the plurality of charge devices. In some embodiments, the determination of the recommended one of the plurality of charge devices includes a determination as to whether the current amount of charge remaining in the battery is sufficient to reach the location of the recommended one of the plurality of charge devices based on the current traffic or construction data corresponding to the one or more routes that lead from the current location to the location of the recommended one of the plurality of charge devices.

In some embodiments, the processor is further configured to determine one or more user preferences based on user preference data, wherein the user preference data includes at least a preference of the user corresponding to an accommodation associated with a charge device, and wherein the accommodation includes at least one of a recreation activity, a restaurant type, a rest stop, a coffee shop, a gas station, or a specific point of interest. The processor is further configured to determine the recommended one of the plurality of charge devices further based on the determined one or more user preferences including the preference of the user corresponding to the accommodation associated with a charge device, wherein the determined recommended one of the plurality of charge devices is associated with the preference of the user such that the charge device is at a same location as the accommodation. In some embodiments, the user preference data is gathered automatically from a user purchase history or a social media account associated with the user. In some embodiments, the user preference data is gathered from a listing of user preferences provided by the user. In some embodiments, the determination of the recommend one of the plurality of charge devices is further based on application of a weight to the determined one or more user preferences in comparison to other factors used in the determination of the recommended one of the plurality of charge devices, wherein the other factors include at least an estimated time of travel to a location of charge device. In some embodiments, the determined one or more user preferences includes a first accommodation and a second accommodation, wherein the first accommodation is determined to have a first priority level and the second accommodation is determined to have a second priority level, wherein the first priority level is higher than the second priority level, and wherein the determination of the recommended one of the plurality of charge devices is further based on a priority level for a determined user preference. In some embodiments, the plurality of charge devices includes a first charge device at a first location and a second charge device at a second location, wherein the first charge device is associated with the first accommodation and the second charge device is associated with the second accommodation, wherein the first location is further away from the current location than the second location. The processor is further configured to determine a first estimated time of travel of the motor vehicle to reach the first location; determine a second estimated time of travel of the motor vehicle to reach the second location; determine a difference between the first estimated time of travel and the second estimated time of travel; and determine if the difference satisfies a difference threshold. If the difference satisfies the difference threshold, the processor is configured to determine the first charge device to be the recommended one of the plurality of charge devices, or, if the difference does not satisfy the difference threshold, the processor is configured to determine the second charge device to be the recommended one of the plurality of charge devices.

In some embodiments, the motor vehicle further comprises a second engine for propelling the motor vehicle on land using gas or diesel, wherein the motor vehicle further includes a fuel gauge configured to sense the amount of gas or diesel remaining in a fuel tank of the motor vehicle, wherein the current motor vehicle data further includes at least fuel remaining data, and wherein the fuel remaining data corresponds to a current amount of fuel remaining in the fuel tank of the motor vehicle. The processor is further configured to determine the recommended one of the plurality of charge devices for recharging the battery of the motor vehicle based on the current motor vehicle data including the fuel remaining data corresponding to the current amount of fuel remaining in the fuel tank of the motor vehicle. In some embodiments, the processor is further configured to factor into the determination of the recommended one of the plurality of charge devices the current amount of fuel remaining in the fuel tank of the motor vehicle when determining if the motor vehicle can reach a location corresponding to a charge device. In some embodiments, the processor is further configured to factor into the determination of the recommended one of the plurality of charge devices whether there is a gas station associated with a charge device such that the charge device is at a same location as the gas station.

In some embodiments, the processor is further configured to determine one or more user preferences based on user preference data, wherein the user preference data includes at least a preference of the user corresponding to a price of recharging using a charge device, charge speed of the charge device, user ratings of the charge device, or a subscription type of the charge device. The processor is further configured to determine the recommended one of the plurality of charge devices further based on the determined one or more user preferences including the preference of the user corresponding to the price of recharging using the charge device, the charge speed of the charge device, the user ratings of the charge device, or the subscription type of the charge device.

In some embodiments, the processor is further configured to determine one or more user preferences based on user preference data, wherein the user preference data includes at least a preference of the user corresponding to a size of parking space associated with a charge device, and wherein the parking space is where the motor vehicle would park while being recharged. The processor is further configured to determine the recommended one of the plurality of charge devices further based on the determined one or more user preferences including the preference of the user corresponding to the size of the parking space associated with the charge device.

In some embodiments, the processor is further configured to determine a time of day associated with a recharging event that would occur with the motor vehicle using a charge device; determine a lighting rating associated with each of the plurality of charge devices, wherein the lighting rating corresponds to the amount of light provided at the location of each of the plurality of charge devices during nighttime; and determine, if the time of day corresponds to nighttime, the recommended one of the plurality of charge devices further based on the lighting rating associated with each of the plurality of charge devices.

In some embodiments, the processor is further configured to determine current route data corresponding to a current route of the motor vehicle that leads to a destination, wherein the current route data includes at least an indication of if there is an available charge device to recharge the battery at the destination; and determine the recommended one of the plurality of charge devices further based on the current route data including if there is the available charge device at the destination. In some embodiments, the processor is further configured to factor into the determination of the recommended one of the plurality of charge devices an amount of time or distance off the current route of the motor vehicle. In some embodiments, the processor is further configured to determine future route data corresponding to a future route of the motor vehicle that leads from the destination; and determine the recommended one of the plurality of charge devices further based on the future route data so as to ensure the motor vehicle will have enough charge remaining once the motor vehicle reaches the destination to make it to another charge device along the future route of the motor vehicle.

In some embodiments, the processor is further configured to dynamically update the determined one of the plurality of charge devices as the motor vehicle travels.

In some embodiments, the processor is further configured to cause presentation of a selectable option for the user to navigate to the recommended one of the plurality of charge devices; receive selection of the selectable option for the user to navigate to the recommended one of the plurality of charge devices; and generate navigation instructions for the motor vehicle to travel to the recommended one of the plurality of charge devices.

In some embodiments, the processor is further configured to determine a recommendation for the user regarding how long to use the recommended one of the plurality of charge devices to recharge the battery based on at least one of the following: a time period associated with performance of a nearby activity for the user or an estimated amount of charge needed to reach a final destination of a current route of the motor vehicle. The processor is further configured to cause presentation of the recommendation to the user.

In some embodiments, the processor is further configured to determine an amount of charge needed for the motor vehicle to reach the recommended one of the plurality of charge devices; determine an adjustment in usage of one or more devices of the motor vehicle that results in decreasing the amount of charge of the battery being used by the one or more devices so as to enable the current amount of charge remaining to be sufficient for the motor vehicle to reach the recommended one of the plurality of charge devices; and provide a recommendation to the user to adjust the usage of the one or more devices of the motor vehicle based on the determined adjustment.

In some embodiments, the processor is further configured to determine an accommodation associated with each of the plurality of charge devices, wherein the accommodation includes at least one of a restaurant, a coffee shop, a gas station, or a convenience store; determine if an offer or promotion is available that corresponds to usage of the recommended one of the plurality of charge devices and usage of or purchase at the accommodation associated with the recommended one of the plurality of charge devices, wherein the recommended one of the plurality of charge devices and the accommodation associated with the recommended one of the plurality of charge devices are at a same location; and cause presentation of the offer or promotion along with the recommended one of the plurality of charge devices to the user. In some embodiments, the processor is further configured to determine one or more user preferences based on user preference data, wherein the user preference data includes at least a preference of a restaurant, a coffee shop, a gas station, or a convenience store; and determine the recommended one of the plurality of charge devices further based on (i) the user preference of a restaurant, a coffee shop, a gas station, or a convenience store, and (ii) if an offer or promotion is available for the accommodation associated with the recommended one of the plurality of charge devices.

In some embodiments, the processor is further configured to determine if an accommodation is associated with each of the plurality of charge devices, wherein the accommodation includes a restaurant; determine if a reservation is available at the restaurant starting within a time window corresponding to an estimated arrival time of the motor vehicle at the recommended one of the plurality of charge devices, wherein the time window is 15 minutes; and cause presentation of an indication that the reservation is available at the restaurant to the user along with the recommended one of the plurality of charge devices to the user.

In some embodiments, the processor is further configured to cause presentation of a selectable option to secure the reservation that is available at the restaurant within the time window; receive a selection of the selectable option to secure the reservation; and cause initiation of securing of the reservation with the restaurant.

Corresponding methods and computer program products are also provided herein.

In another example embodiment, a system for recommending how long to use a charge device for recharging a battery of an electric powered motor vehicle is provided. The system comprises a motor vehicle comprising an engine for propelling the motor vehicle on land using electrical energy, a battery for providing the electrical energy to the engine, wherein the battery is rechargeable, and a battery sensor configured to sense an amount of charge remaining in the battery. The system further includes a memory and a processor configured, when executing computer program product code stored in the memory, to receive current motor vehicle data, wherein the current motor vehicle data includes at least charge remaining data, and wherein the charge remaining data corresponds to a current amount of charge remaining in the battery. The processor is further configured to determine a charge device for recharging the battery of the motor vehicle; receive charge device data corresponding to the determined charge device, wherein the charge device data includes at least a charge speed of the charge device; determine a recommendation for an amount of time to use the determined charge device to recharge the battery based on at least the following: the charge device data including the charge speed of the charge device and the charge remaining data including the current amount of charge remaining in the battery; and cause presentation of the recommendation to a user.

In some embodiments, the processor is further configured to determine an estimated amount of charge to be recharged while using the charge device for the recommended amount of time; and cause presentation of at least one of a representation of the estimated amount of charge to be recharged or an estimated amount of future mileage capability of the motor vehicle after addition of the estimated amount of charge to be recharged.

In some embodiments, the charge device data further includes a location corresponding to the determined charge device, wherein the processor is further configured to determine a current location of the motor vehicle. In some embodiments, the processor is further configured to provide a selectable option to reserve the determined charge device; receive a selection of the selectable option to reserve the determined charge device; determine, based on the current location and the charge device data including the location of the charge device, an estimated time of arrival of the motor vehicle at the charge device; and cause initiation of a reservation of the determined charge device for a time period corresponding to the estimated time of arrival of the motor vehicle at the charge device. In some embodiments, the processor is further configured to provide a selectable option to cause initiation of navigation to the determined charge device; receive a selection of the selectable option to cause initiation of navigation to the determined charge device; and cause initiation of navigation for the motor vehicle to the determined charge device. In some embodiments, the processor is further configured to determine an accommodation located within a distance of the determined charge device, wherein the accommodation includes at least one of a recreation activity, a restaurant type, a rest stop, a coffee shop, or a gas station, wherein the distance is 0.25 miles or less; determine a time period associated with usage of the accommodation, wherein the time period associated with usage of the accommodation corresponds to how long the user may likely spend at the accommodation; determine the recommendation for the amount of time to use the determined charge device to recharge the battery further based on the determined time period associated with usage of the accommodation; and cause presentation of a recommendation to use the accommodation while using the determined charge device. In some embodiments, the processor is further configured to determine if an offer or promotion is available that corresponds to usage of the accommodation; and cause presentation of the offer or promotion along with the recommendation to use the accommodation while using the determined charge device. In some embodiments, the offer or promotion is further based on utilizing the determined charge device for the recommended amount of time. In some embodiments, the processor is further configured to determine current route data corresponding to a current route of the motor vehicle that leads to a destination; determine an estimated amount of charge needed to reach the destination; and determine the recommendation for the amount of time to use the determined charge device to recharge the battery further based on the estimated amount of charge needed to reach the destination. In some embodiments, the processor is further configured to determine current route data corresponding to a current route of the motor vehicle that leads to a destination; determine if there is an available charge device to recharge the battery at the destination; determine a location of a next charge device near the destination; determine an estimated amount of charge needed to reach the destination and then the location of the next charge device from the destination; and determine the recommendation for the amount of time to use the determined charge device to recharge the battery further based on the estimated amount of charge needed to reach the destination and then the location of the next charge device from the destination.

Corresponding methods and computer program products are also provided herein.

In yet another example embodiment, a system for recommending adjustment of operation of one or more devices of a motor vehicle to extend estimated travel distance for the motor vehicle based on a current amount of charge of a battery used to provide electrical energy for an electric powered engine of the motor vehicle is provided. The system comprises a motor vehicle comprising an engine for propelling the motor vehicle on land using electrical energy, a battery for providing the electrical energy to the engine, wherein the battery is rechargeable, a battery sensor configured to sense an amount of charge remaining in the battery; at least one device of the motor vehicle that draws electrical energy from the battery when operating, wherein the at least one device is different than the engine; memory; and a processor. The processor is configured, when executing computer program product code stored in the memory, to receive current motor vehicle data, wherein the current motor vehicle data includes at least charge remaining data, and wherein the charge remaining data corresponds to a current amount of charge remaining in the battery. The processor is further configured to determine an adjustment in usage of the at least one device of the motor vehicle that results in decreasing the amount of charge of the battery being used by the at least one device; determine an extended estimated travel distance for the motor vehicle based on the current amount of charge remaining in the battery with the determined adjustment in usage of the at least one device of the motor vehicle; and provide a recommendation to the user to adjust the usage of the at least one device of the motor vehicle based on the determined adjustment along with an indication of the determined extended estimated travel distance.

In some embodiments, the processor is further configured to determine a first estimated travel distance for the motor vehicle based on the current amount of charge remaining in the battery while the at least one device is operating in a current mode; and provide the indication of the determined extended estimated travel distance so as to indicate a difference between the extended estimated travel distance and the first estimated travel distance.

In some embodiments, the at least one device comprises at least one of an air conditioner, a heater, a phone charger, an entertainment system, or wireless communication network system.

In some embodiments, the processor is further configured to determine current route data corresponding to a current route of the motor vehicle that leads to a destination; determine a first estimated travel distance for the motor vehicle based on the current amount of charge remaining in the battery while the at least one device is operating in a current mode; determine that the first estimated travel distance is insufficient to enable the motor vehicle to reach the destination; and determine the adjustment in usage of the at least one device of the motor vehicle so as to cause the extended estimated travel distance of the motor vehicle to enable the motor vehicle to reach the destination. In some embodiments, the processor is further configured to determine the adjustment in usage of the at least one device of the motor vehicle further based on traffic or construction along one or more routes that lead to the destination. In some embodiments, the processor is further configured to determine if there is an available charge device to recharge the battery at the destination; determine a location of a next charge device near the destination; and determine the adjustment in usage of the at least one device of the motor vehicle so as to cause the extended estimated travel distance of the motor vehicle to enable the motor vehicle to reach the destination and then to reach the location of the next charge device from the destination.

In some embodiments, the processor is further configured to determine a location of a charge device; determine a first estimated travel distance for the motor vehicle based on the current amount of charge remaining in the battery while the at least one device is operating in a current mode; determine that the first estimated travel distance is insufficient to enable the motor vehicle to reach the location of the charge device; and determine the adjustment in usage of the at least one device of the motor vehicle so as to cause the extended estimated travel distance of the motor vehicle to enable the motor vehicle to reach the location of the charge device. In some embodiments, the processor is further configured to determine the adjustment in usage of the at least one device of the motor vehicle further based on traffic or construction along one or more routes that lead to the location of the charge device.

In some embodiments, the processor is further configured to cause display of a map including a current location of the motor vehicle; determine a first estimated travel distance for the motor vehicle based on the current amount of charge remaining in the battery while the at least one device is operating in a current mode; cause display of an overlay on the map indicating one or more locations on the map where the motor vehicle is able to travel to based on the first estimated travel distance; and cause update of the overlay on the map to indicate one or more location on the map where the motor vehicle is able to travel to based on the extended estimated travel distance. In some embodiments, the overlay applies shading to locations on the map that are unreachable by the motor vehicle based on either the first estimated travel distance or the extended estimated travel distance.

Corresponding methods and computer program products are also provided herein.

In yet another example embodiment, a system for indicating an estimated travel distance for a motor vehicle based on a current amount of charge of a battery used to provide electrical energy for an electric powered engine of the motor vehicle is provided. The system comprises a motor vehicle comprising an engine for propelling the motor vehicle on land using electrical energy, a battery for providing the electrical energy to the engine, wherein the battery is rechargeable, and a battery sensor configured to sense an amount of charge remaining in the battery. The system further includes memory and a processor. The processor is configured, when executing computer program product code stored in the memory, to receive current motor vehicle data, wherein the current motor vehicle data includes at least charge remaining data, and wherein the charge remaining data corresponds to a current amount of charge remaining in the battery. The processor is further configured to determine a current location of the motor vehicle; cause display of a map including the current location of the motor vehicle; determine an estimated travel distance for the motor vehicle based on the current amount of charge remaining in the battery; determine an overlay for the map indicating one or more locations on the map where the motor vehicle is able to travel to based on the estimated travel distance and one or more locations on the map where the motor vehicle is unable to travel based on the estimated travel distance; and cause display of the overlay on the map.

In some embodiments, display of the overlay applies shading to the one or more locations on the map where the motor vehicle is unable to travel based on the estimated travel distance. In some embodiments, the shading is applied outside of buildings or map features that are at positions along the road that are reachable by the motor vehicle.

In some embodiments, the processor is further configured to determine current traffic or construction data corresponding with one or more routes that the motor vehicle could travel along; and determine the overlay based on the current traffic or construction data such that the one or more locations on the map where the motor vehicle is unable to travel is updated based on the traffic or construction data. In some embodiments, the processor is further configured to determine an adjustment in usage of the at least one device of the motor vehicle that results in decreasing the amount of charge of the battery being used by the at least one device; determine a second estimated travel distance for the motor vehicle based on the current amount of charge remaining in the battery with the determined adjustment in usage of the at least one device of the motor vehicle; and cause the overlay to be updated based on the second estimated travel distance. In some embodiments, the motor vehicle further comprises a second engine for propelling the motor vehicle on land using gas or diesel, wherein the motor vehicle further includes a fuel gauge configured to sense the amount of gas or diesel remaining in a fuel tank of the motor vehicle, wherein the current motor vehicle data further includes at least fuel remaining data, and wherein the fuel remaining data corresponds to a current amount of fuel remaining in the fuel tank of the motor vehicle. The processor is further configured to determine, based on the current motor vehicle data, the overlay to include an indication of one or more locations where the motor vehicle is able to reach using the second engine once the current amount of charge remaining in the battery is depleted. In some embodiments, the overlay includes a first shading showing the one or more locations on the map where the motor vehicle is able to travel to based on the estimated travel distance corresponding to the current amount of charge remaining in the battery and a second shading showing the one or more locations where the motor vehicle is able to reach using the second engine once the current amount of charge remaining in the battery is depleted, wherein the first shading is different than the second shading.

In some embodiments, the processor is further configured to dynamically update the overlay as the motor vehicle travels.

Corresponding methods and computer program products are also provided herein.

In yet another example embodiment, a system for providing an offer or promotion for using a charge device for recharging a battery of an electric powered motor vehicle is provided. The system comprises a motor vehicle comprising an engine for propelling the motor vehicle on land using electrical energy, a battery for providing the electrical energy to the engine, wherein the battery is rechargeable, and a battery sensor configured to sense an amount of charge remaining in the battery. The system further includes memory and a processor configured, when executing computer program product code stored in the memory, to receive current motor vehicle data, wherein the current motor vehicle data includes at least charge remaining data, and wherein the charge remaining data corresponds to a current amount of charge remaining in the battery. The processor is further configured to determine a charge device for recharging the battery of the motor vehicle; receive current charge device data corresponding to the determined charge device, wherein the current charge device data includes at least a location corresponding to the determined charge device; determine a plurality of offers or promotions available that correspond to usage of the determined charge device and usage of or purchase at at least one accommodation associated with the determined charge device, wherein the determined charge device is within a threshold distance from the at least one accommodation associated with the determined charge device, wherein the threshold distance is 0.5 miles; determine an offer or promotion of the plurality of offers or promotions available to present to a user of the motor vehicle; and cause presentation of the determined offer or promotion to the user.

In some embodiments, the processor is further configured to determine one or more user preferences based on user preference data, wherein the user preference data includes at least a preference of a restaurant, a coffee shop, a gas station, or a convenience store; and determine the offer or promotion of the plurality of offers or promotions based on the one or more user preferences such that the determined offer or promotion corresponds with the preference of a restaurant, a coffee shop, a gas station, or a convenience store.

In some embodiments, the processor is further configured to determine, based on the charge remaining data, a recommended length of usage of the determined charge device; and determine the offer or promotion of the plurality of offers or promotions such that an anticipated time of usage of the offer or promotion corresponds with the recommended length of usage of the determined charge device.

Corresponding methods and computer program products are also provided herein.

### BRIEF DESCRIPTION OF THE SEVERAL VIEWS OF THE DRAWINGS

Having described embodiments of the invention in general terms, reference will now be made to the accompanying drawings, which are not necessarily drawn to scale, and wherein:

FIG. 1 illustrates an example motor vehicle with an electric engine charging using an example charge device, in accordance with some example embodiments described herein;

FIG. 2 illustrates the example motor vehicle with the electric engine charging using another example charge device, in accordance with some example embodiments described herein;

FIG. 3 illustrates an example system for providing one or more recommendations related to charging a battery of a motor vehicle with an electric engine, in accordance with some example embodiments described herein;

FIG. 4 illustrates an example user profile for a user of a motor vehicle with an electric engine, in accordance with some example embodiments described herein;

FIG. 5 shows a map illustrating various roads, charge devices, and example associated accommodations near a motor vehicle, in accordance with some example embodiments described herein;

FIG. 6 illustrates example recommended charge devices and corresponding recommendations and information regarding the charge devices, in accordance with some example embodiments described herein;

FIGS. 7A-B illustrate additional recommended charge devices and one or more options corresponding to the recommended charge device, in accordance with some example embodiments described herein;

FIG. 8 shows the map illustrated in FIG. 5, with additional information regarding some of the charge devices displayed thereon, in accordance with some example embodiments described herein;

FIG. 9 illustrates an example display illustrating current motor vehicle data, in accordance with some example embodiments described herein;

FIGS. 10A-C illustrate recommended charge devices along with corresponding recommendations and information regarding the charge devices, in accordance with some example embodiments described herein;

FIG. 11 illustrates another example display illustrating current motor vehicle data, in accordance with some example embodiments described herein;

FIG. 12 illustrates another recommended charge device along with corresponding recommendations and information regarding the charge device, in accordance with some example embodiments described herein;

FIG. 13 shows the map illustrated in FIG. 5, with an overlay that indicates one or more locations that are outside a current estimated travel distance range of the motor vehicle, in accordance with some example embodiments described herein;

FIG. 14A shows the map illustrated in FIG. 13, with the overlay including shading of the one or more locations that are outside the current estimated travel distance range of the motor vehicle, in accordance with some example embodiments described herein;

FIG. 14B shows the map illustrated in FIG. 14A, with the overlay including a second shading, where the difference between the shadings illustrates where the motor vehicle could reach if the recommended adjustment of an additional device of the motor vehicle occurs, in accordance with some example embodiments described herein;

FIG. 14C shows the map illustrated in FIG. 5, with an overlay including a first shading showing where the motor vehicle can reach if gas is used and a second shading showing one or more locations that are outside the current estimated travel distance range of the motor vehicle even including gas, in accordance with some example embodiments described herein;

FIG. 15 shows a map illustrating a current planned route of a motor vehicle, wherein the route includes stopping at charge devices along the route, in accordance with some example embodiments described herein;

FIG. 16 shows the map illustrated in FIG. 15, where the route has been updated to reflect that there is no available charge device at the destination, in accordance with some example embodiments described herein;

FIG. 17 shows the map illustrated in FIG. 15, where the route has been updated based on a deviation from the prior planned route, in accordance with some example embodiments described herein;

FIG. 18 illustrates a schematic block diagram of an example system for providing recommendations and features related to electric vehicle battery charging, in accordance with some example embodiments described herein;

FIG. 19 illustrates a flowchart of an example method for recommending one or more charge devices, in accordance with some example embodiments described herein;

FIG. 20 illustrates a flowchart of an example method for providing a recommendation regarding one or more charge devices, in accordance with some example embodiments described herein;

FIG. 21 illustrates a flowchart of an example method for providing a recommendation regarding usage of one or more additional devices, in accordance with some example embodiments described herein; and

FIG. 22 illustrates a flowchart of an example method for providing an overlay for a map illustrating an estimated travel distance range for a motor vehicle, in accordance with some example embodiments described herein.

### DETAILED DESCRIPTION

Some embodiments of the present invention will now be described more fully hereinafter with reference to the accompanying drawings, in which some, but not all embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout.

As used herein, the terms “data,” “content,” “information” and similar terms may be used interchangeably to refer to singular or plural data capable of being transmitted, received, analyzed, displayed and/or stored in accordance with various example embodiments. Thus, use of any such terms should not be taken to limit the spirit and scope of the disclosure.

The term “computer-readable medium” as used herein refers to any medium configured to participate in providing information to a processor, including instructions for execution. Such a medium may take many forms, including, but not limited to a non-transitory computer-readable storage medium (e.g., non-volatile media, volatile media), and transmission media. Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Examples of non-transitory computer-readable storage media include a magnetic computer readable medium (e.g., a floppy disk, hard disk, magnetic tape, any other magnetic medium), an optical computer readable medium (e.g., a compact disc read only memory (CD-ROM), a digital versatile disc (DVD), a Blu-Ray disc, or the like), a random access memory (RAM), a programmable read only memory (PROM), an erasable programmable read only memory (EPROM), a FLASH-EPROM, or any other non-transitory medium from which a computer can read.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

Additionally, as used herein, although the figures and examples may refer to users such as drivers, vehicle users, or application users, other types of users are contemplated (e.g., passengers, service providers, charge device attendants, etc.). Indeed, example embodiments of the present invention may be used with any type of user.

As used herein, the terms “charge” or “charging” or “recharge” or “recharging” are meant to be interchangeable unless otherwise specified.

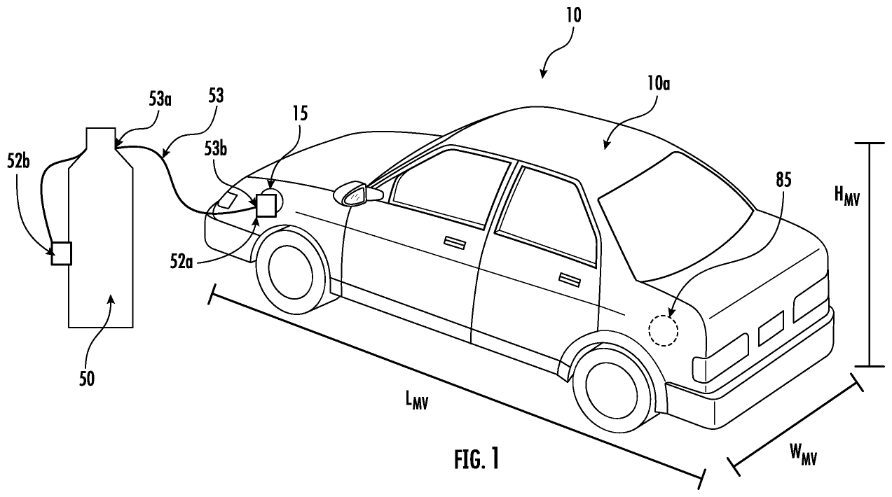

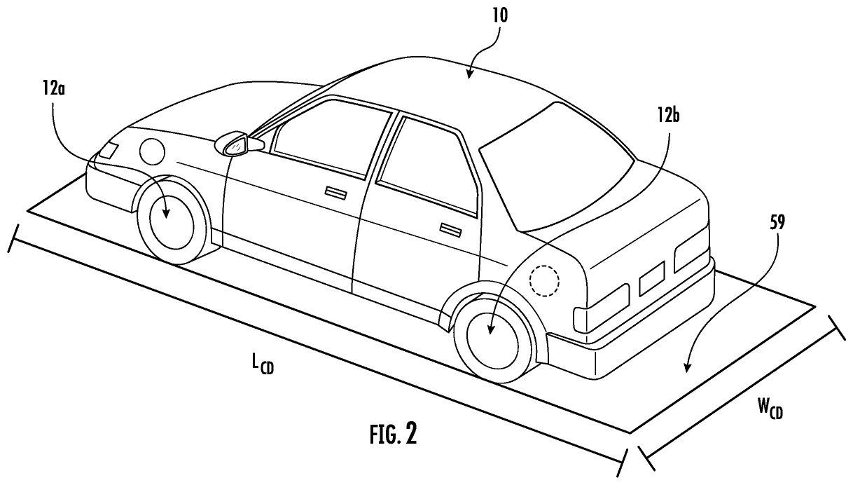

FIG. 1 illustrates an example motor vehicle 10 (e.g., a car, a truck, a tank, etc.) configured to travel over land, such as via roadways, open land, or otherwise (although embodiments of the present invention are not meant to be so limited unless otherwise specified). The motor vehicle 10 illustrated in FIG. 1 includes a vehicle body 10a that generally defines a length L_{MV}, a width W_{MV}, and a height H_{MV}. Although the illustrated vehicle body 10a is that of a sedan, other vehicle body shapes and sizes are contemplated (e.g., sport utility vehicle, crossover, truck, semi-truck, tank, etc.).

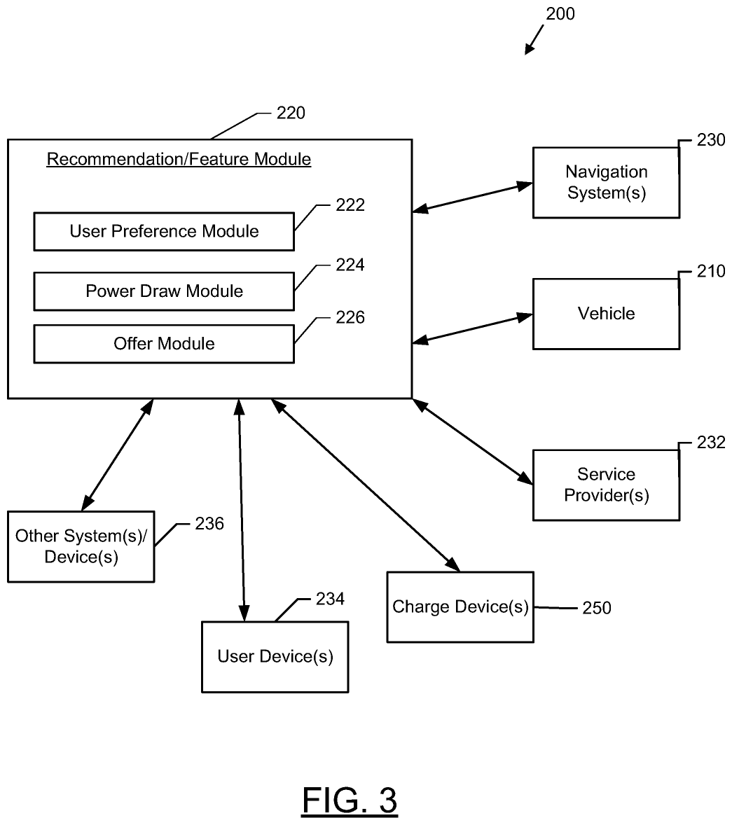

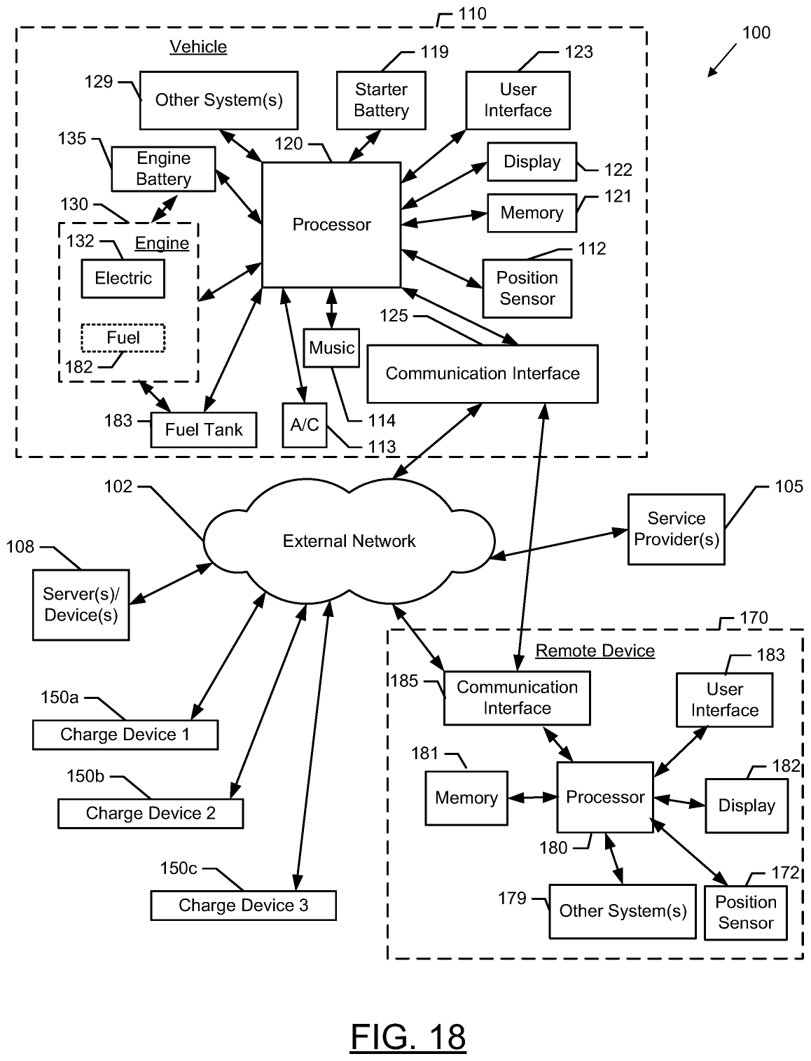

The motor vehicle 10 (with further reference to FIG. 18) includes various components and/or systems that enable operation of the motor vehicle 10. The motor vehicle 10 includes at least one engine (e.g., engine 130 in FIG. 18) that operates to propel the motor vehicle over land. In this regard, in known manner, the motor may operate to cause rotation of one or more wheels (e.g., wheels 12a, 12b in FIG. 2) or other movement elements (e.g., belt tracks, etc.), such as through one or more axles, to cause the motor vehicle 10 to move along the land. The motor may vary power and/or speed, such as via a controller (e.g., processor 120, processor 180, and/or other remote server(s)/device(s) 108, such as shown in FIG. 18) or other component(s). A user may control the speed and/or power through one or more user inputs (e.g., via user interface 123 in FIG. 18), such as foot pedal, etc. A user may also control a direction of travel through one or more user inputs (e.g., user interface 123 in FIG. 18), such as via a steering wheel, joystick, or other control. In some embodiments, the controller may automatically control power, speed, or direction (among other things), such as via an autopilot and/or through a navigation module (e.g., through Navigation System(s) 230 in FIG. 3), to cause the motor vehicle 10 to travel along the land.

The at least one engine is configured to utilize electrical energy to operate (e.g., electric engine 132 in FIG. 18), such as provided by one or more batteries (e.g., engine battery 135 in FIG. 18). In this regard, the motor vehicle 10 is considered an electric vehicle. In some embodiments, however, the engine of the motor vehicle 10 may also operate using energy provided from fuel (e.g., gas, diesel, etc.) (e.g., fuel engine 182 in FIG. 18), such as from a fuel tank (e.g., fuel tank 183 in FIG. 18). Such an example motor vehicle may be considered a hybrid vehicle. Depending on the configuration of the motor vehicle 10, there may be one engine that is capable of operating from power provided by either electrical energy or fuel (or both simultaneously) or there may be two engines (one that operates based on electrical energy and another that operates based on fuel).

Returning to FIG. 1, the motor vehicle 10 may include one or more battery charging ports 15 that enable electrical energy to be transferred to the engine battery to recharge the battery. In this regard, the motor vehicle 10 includes a rechargeable engine battery. Notably, an engine battery has limited storage capacity, resulting in a limited travel distance range for the motor vehicle 10 depending on the amount of charge remaining in the battery. For example, many current motor vehicles that operate using electric engines have an engine battery that enables around 200-300 miles of travel distance on a fully charged engine battery. This means that the engine battery will need to be recharged if the user wants to travel further than that distance. FIG. 1 illustrates an example charge device 50 that is being used to recharge the engine battery of the motor vehicle 10. In this regard, a first charge plug 52a is plugged into the port 15 of the motor vehicle 10. The first charge plug 52a is positioned at a first end 53a of a charging hose 53 that is connected to the charge device 50 at a second end 53b. The charging hose 53 enables electrical energy to flow from the charge device 50 through the first charge plug 52a and into the motor vehicle 10 to recharge the engine battery (and fill back up the amount of charge remaining in the engine battery). The charge device 50 may include more than one charge plug. For example, as illustrated, the charge device 50 includes a second charge plug 52b. In some embodiments, the charge device 50 may include one or more charge plug adapters that are offered to enable connection of the charge plug into different types of ports.

As noted herein, in some embodiments, an engine of the motor vehicle 10 may be operated using fuel (e.g., gas, diesel, etc.). In the illustrated embodiment, the motor vehicle 10 includes a fuel port 85 that enables fuel to be provided therethrough to resupply the fuel tank of the motor vehicle 10.

While FIG. 1 illustrates a plug charge device, other types of charge devices are contemplated by various embodiments of the present invention. For example, FIG. 2 illustrates an example pad charge device 59 that recharges an engine battery positioned over the pad charge device 59. In this regard, the wheels 12a, 12b of the motor vehicle are positioned such that at least the engine battery is vertically over the pad charge device 59 to enable electrical energy to flow to the engine battery to recharge it accordingly. In the illustrated embodiment, the pad charge device 59 defines a length L_{CD} and width W_{CD} that is large enough for the motor vehicle 10 to fit thereon. In some embodiments, other sizes of pad charge devices are contemplated. Along similar lines, other types of charge devices are contemplated (e.g., other types of wired or wireless charge devices).

In some embodiments, charge devices 50 may provide battery swap(s) that enable replacement of one or more batteries of the vehicle. This may be offered in addition to or in the alternative to recharging options, such as described above.

While charge devices are available, they are currently limited as the infrastructure for electric vehicles has not caught up to the infrastructure for fuel consuming vehicles. Further, recharging an engine battery with a charge device often takes hours, typically 4+ hours for a full recharge. While there are likely to be increases in travel distance range and increases in charge speed for charge devices, those changes will not likely occur soon and this leaves current users of electric vehicles with the problem of when and where to charge their engine batteries (and what to do while they charge). Further, these difficulties lead to concern of a user that wants to otherwise use their electric vehicle but is afraid to run out of charge in the engine battery. This may be particularly true for use of the electric vehicle on, for example, longer road trips, such as ones that will require intermittent recharging of the engine battery and/or where there is no charge device (or charge device uncertainty) at the destination (e.g., the destination is a rental house (which may not allow charging of electric vehicles), the destination is a relative's house, the destination is a hospital, the destination is a camp ground, there may be a power outage, etc.).

Accordingly, embodiments of the present invention provide methods and systems that attempt to alleviate the concerns of users of electrically powered motor vehicles and provide various recommendations and features to aid the user in, for example, finding charge devices, selecting charge devices, finding desirable activities to do while the battery is charging, trip planning, and general operation of electrically powered motor vehicles.

FIG. 3 illustrates an example system 200 for providing one or more recommendations or features related to electric motor vehicle recharging. The system 200 includes a recommendation/feature module 220 that utilizes data from various systems/devices, such as one or more navigation systems 230, one or more vehicles 210 (including the user motor vehicle), one or more service providers 232, one or more charge devices 250, one or more user devices 234 (e.g., a user's smartphone, computer, smartwatch, home speaker, or other devices), or other systems/devices 236. In this regard, the recommendation/feature module 220 may gather data from the various systems/devices and perform one or more methods and/or algorithms to arrive at a tailored recommendation and/or feature, such as described in various embodiments herein.

The one or more navigation systems 230 may include any system used to provide navigation and/or chart (e.g., map) functionality. For example, the one or more navigation systems 230 may provide chart data, including, for example, route data, roadway data, traffic data, points of interest data, accommodation data (e.g., points of interest, parks, campgrounds, gas stations, restaurants, businesses, coffee shops, sightseeing, etc.), weather data, time data, charge device data, among other types of data related to navigation of the motor vehicle and possible destinations for the motor vehicle. In some embodiments, the different types of data may include locations related thereto and/or other things (e.g., the name of the accommodation, offerings, promotions, time of operation, etc.). In some embodiments, the recommendation/feature module 220 may be configured to query or otherwise gather data from the one or more navigation systems 230 for use for providing one or more recommendations or features described herein.

The one or more vehicles 210 may include any vehicle, and may, particularly, include the motor vehicle currently being operated or planned for operation. The one or more vehicles 210 may provide any vehicle data related to the motor vehicle, such as current motor vehicle data regarding the motor vehicle. Some example motor vehicle data includes the size and/or shape of the motor vehicle, the type of motor vehicle, the identification number of the motor vehicle, the owner, profiles of various drivers of the motor vehicle, engine battery data (including, current amount of charge, full amount of charge, etc.), one or more additional devices/systems used by the motor vehicle and their battery usage, engine type of the motor vehicle, location of the charge port on the motor vehicle, fuel type for a fuel consuming engine of the motor vehicle, size of the fuel tank, current amount of fuel in the fuel tank, current location of the motor vehicle, maintenance data (e.g., tire pressure, inspection due date, oil change data, etc.), weight of the vehicle, occupant capacity of the vehicle, current occupants (e.g., gathered from smartphone data, preferences, user input, etc.), among many other types of data regarding the motor vehicle (some of which are described in various example embodiments herein). In some embodiments, the recommendation/feature module 220 may be configured to query or otherwise gather data from the one or more vehicles 210 for use for providing one or more recommendations or features described herein.

The one or more service providers 232 may include any service provider, such as any service provider associated with one or more accommodations, such as to which the motor vehicle may travel to. In some embodiments, the service provider may be a service provider associated with one or more of the charge devices. In some embodiments, the service provider may be a service provider that has an offer or promotion available. In this regard, the service providers may provide offer or promotion data related to one or more offers or promotions, such as related to services or products associated with an accommodation. In some embodiments, the service providers may provide service or product data corresponding to services or products available that may be, for example, associated with an accommodation. This may, for example, include time of operation data, location data, subscription data, or other types of service or product data. In some embodiments, the recommendation/feature module 220 may be configured to query or otherwise gather data from the one or more service providers 232 for use for providing one or more recommendations or features described herein.

The one or more charge devices 250 may include any charge device (e.g., plug charge device, pad charge device, etc.) that may be used to recharge an engine battery of a motor vehicle. The one or more charge devices 250 may provide charge device data regarding the charge device. For example, the charge device data may include a name or identifier of the charge device, a location of the charge device, a price associated with use of the charge device, a subscription associated with use of the charge device, any associated accommodations, any nearby accommodations, the charge speed offered by the charge device, user ratings, safety ratings, if and/or what lighting is available for the charge device (e.g., if charging at night), availability data corresponding to if the charge device is currently available for use, reservation data corresponding to future reservations (e.g., if they are available, when they are available, etc.), offer or promotion data associated with the charge device or an accommodation, how many plug charge devices are offered by the charge device, size and/or shape data regarding the parking space associated with the charge device (e.g., for semi-trucks, vans, compact, etc.), usage data (e.g., how often is the charge device used, etc.), the type of charge plug, if any charge plug adapters are available and/or which ones are available, if any battery swap(s) are available, type of battery swap(s) available, number of battery swap(s) available, among other types of data corresponding to a charge device. In some embodiments, the recommendation/feature module 220 may be configured to query or otherwise gather data from the one or more charge devices 250 for use for providing one or more recommendations or features described herein.

The one or more user devices 234 may include any type of device or system associated with a user. The user device 234 may provide user data, including, for example, user preference data, user history data, user social media data, user profile data, user purchase data, among other types of data corresponding to the user. Some example user devices include a user's smartphone, smartwatch, profiles on social media, profiles at service providers, personal computers, home speakers, a user's home charge device, etc. In some embodiments, the recommendation/feature module 220 may be configured to query or otherwise gather data from the one or more user devices 234 for use for providing one or more recommendations or features described herein.

The other system(s)/device(s) 236 may include any system or device that may provide data to the recommendation/feature module 220 for use in providing recommendations or features such as described herein. Some example other system(s)/device(s) 236 include GPS systems, radio systems, local news systems, weather systems, among others.

Depending on the desired recommendation or feature, the recommendation/feature module 220 may utilize one or more additional modules, such as a user preference module 222, a power draw module 224, or an offer module 226—although other types of modules are contemplated herein.

A user preference module 222 may take in data from the various systems/devices and determine user preference data (although additionally or alternatively, in some embodiments, user preference data may be gathered from another system/device such as the one or more user devices 234). The user preference data may relate to any type of user preference, such as related to types of food, restaurants, parks, activities, gas stations, charge device preferences (e.g., distance, price, charge speed, subscription, whether a reservation is preferred, parking spaces associated with the charge device, safety ratings, user ratings, associated accommodations, etc.), sports teams, tourism activity, music, temperature level within the motor vehicle, music volume within the motor vehicle, etc. (such as described herein). Notably, user preferences may indicate likes and dislikes.

In some embodiments, the user preference data may have weights assigned to them, such as indicating an order of priority and/or an importance level. In some embodiments, the user preference module 222 may be configured to gather information from and/or create a user profile that details one or more user preferences. In some embodiments, a user may be prompted to create a user profile along these lines. In some embodiments, the user profile may be automatically created. In some embodiments, data gathered from various systems/devices may be used to create the user profile (and/or user preferences). For example, user purchase history data, social media data, etc. may be used to generate the user preferences.

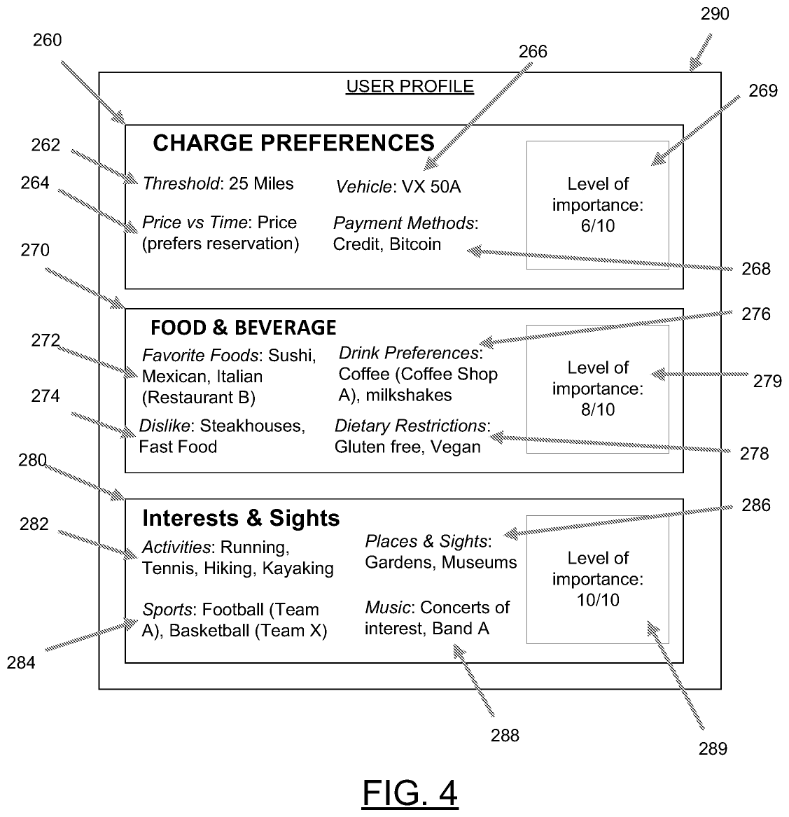

FIG. 4 illustrates an example user profile 290 indicating some example user preferences that may be factored in for the recommendation/feature module 220. The user profile 290 includes charge preferences 260, food and beverage preferences 270, and interests and sights preferences 280, although other types of preferences are contemplated (and different names or identifiers for the types of preferences). Notably, the following user preferences are provided merely as examples and corresponding other preferences are contemplated. For example, if a user preference is indicated herein as Mexican food, embodiments of the present invention merely contemplate that any type of food (or restaurant) could be indicated as a user preference and provides “Mexican” merely as one such example.

Under charge preferences 260, the user has a preference of a maximum threshold distance 262 of 25 miles. In this regard, the recommendation/feature module 220 may not recommend a charge device that is outside of 25 miles from the current location of the user and/or motor vehicle. In some embodiments, a route distance threshold may be provided that would indicate a threshold distance off a planned route that a user is willing to travel for a charge device. The user also has a price v. time preference 264 that indicates that the user would prefer reduced pricing over time when it comes to charging, for example, the user is willing to have the charge time take longer in order to receive reduced pricing. In this regard, the user is presented with cheaper price options that may take longer when charge devices are recommended. The user also has a preference to utilize reservations with charge devices, such that a user can make a reservation to utilize the charge device. Notably, other types of preferences are contemplated, such as thresholds for charging speeds, price per hour thresholds, etc. Another example charge preference of vehicle type 266 is also detailed. This may provide vehicle data indicating the type of vehicle being charged, which could be used to factor in various features of the charge device such as plug location, height restrictions, parking space sizing, etc. The user also has a user payment preference 268 of using credit or bitcoin. In the illustrated embodiment, a priority or importance level 269 has been set for the charge preferences of 6 out of 10 (although any type of scale or weight is contemplated). Such a priority or importance level may be factored in when the recommendation/feature module 220 has determined a recommendation or feature to provide. In some embodiments, a priority or importance level may be applied to any of the individual charge preferences (and not the same level to all of the charge preferences). In some embodiments, a user may have a minimum charge threshold that may cause the system to make sure the charge level of the battery will not drop below the charge threshold (e.g., 5%, 10 miles remaining, etc.). Accordingly, the system may make recommendations of charge devices such that the vehicle arrives at the charge device with sufficient charge level remaining to meet the minimum charge threshold. This provides the user peace of mind and comfort without having to stress about potentially not making it to the next available charge. Such a minimum charge threshold may be user set and/or determined based on user data.

Under food and beverage preferences 270, a user has a favorite food preference 272 of sushi, Mexican, and Italian (particularly, “Restaurant B”). Such user preference data may, for example, be used to recommend an offer or promotion and/or a charge device located near or associated with (e.g., at the same location, within 0.25 miles, within 0.5 miles, etc.) an accommodation offering the favorite food. The user also, however, may have dislikes 274 of steakhouses or fast food, which may factor into any recommended charge device and/or offer or promotion as well. The user also has a drink preference 276 of coffee (particularly from “Coffee Shop A”) and milkshakes. The user further has a dietary restriction 278 of gluten free and vegan, which may be factored in. The priority or importance level 279 for the food and beverage preferences 270 is 8 out of 10, meaning the user values food and beverage preferences more than charge preferences. As indicated herein, the priority or importance levels could be applied to individual ones or groups of the preferences. Such information may be factored in by the recommendation/feature module 220.

Under interests and sights preferences 280, a user has preferred activities 282 of running, tennis, hiking, and kayaking. Such user preference data may, for example, be used to recommend an offer or promotion and/or a charge device located near or associated with (e.g., at the same location, within 0.25 miles, within 0.5 miles, etc.) an accommodation offering one of those activities. Further, if priority or importance levels are assigned to the activities, that may be factored in as to which accommodation and charge device to recommend (and/or offer or promotion). The user also may have favorite sports 284 of football (Team A) and basketball (Team X), which may factor into any recommended charge device and/or offer or promotion as well. The user also has a places and sights preference 286 of gardens and museums. The user further has a music preference 288 of concerts, and B and C, which may be factored in. The priority or importance level 289 for the interests and sights preferences 280 is 10 out of 10, meaning the user values interests and sights preferences more than food and beverage preferences or charge preferences. As indicated herein, the priority or importance levels could be applied to individual ones or groups of the preferences. Such information may be factored in by the recommendation/feature module 220.

Returning to FIG. 3, a power draw module 224 may take in data from the various systems/devices and determine power draw data associated with various devices within the motor vehicle. For example, one or more devices may be drawing electrical power from the engine battery—such that the power draw may affect the estimated travel distance available under the current amount of charge in the battery. The power draw module 224 may gather data, such as motor vehicle data from the one or more vehicles 210 and/or other data and determine if any power draw is occurring and what is causing the power draw. Such data may include how adjustments in operation of the one or more devices may affect future usage of the remaining amount of charge of the battery. Such information, as described further herein, can be used to alert the user and/or provide recommendations or features corresponding to optimizing usage of the electric motor vehicle.

An offer module 226 may take in data from the various systems/devices and determine offer or promotion data associated with various accommodations and/or charge devices. For example, the offer module 226 may determine available offers or promotions associated with a charge device (e.g., for use with the charge device, for use with an accommodation associated with the charge device, etc.). In some embodiments, the offer module 226 may work with the user preference module 222 to provide user tailored offer or promotion data to the recommendation/feature module 220.

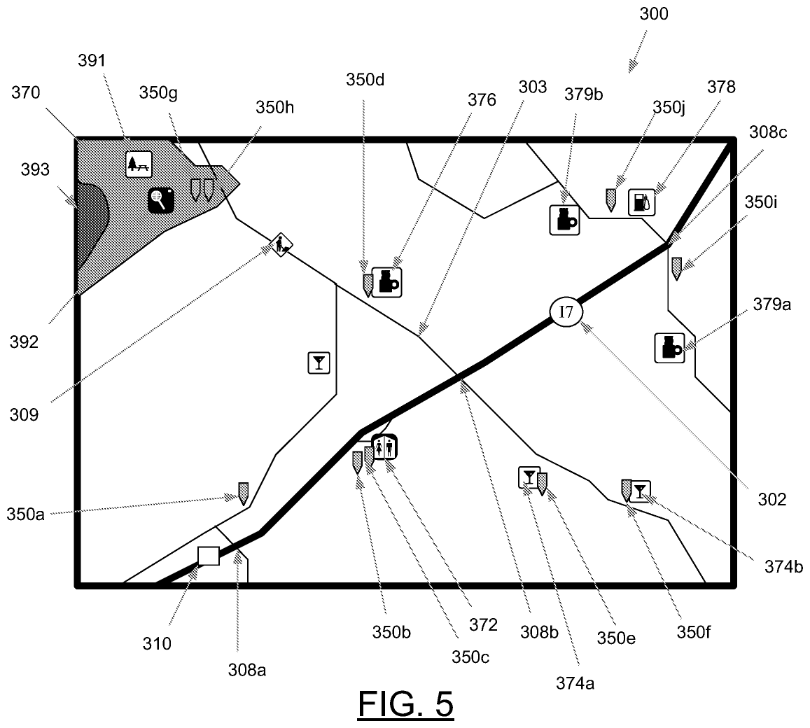

FIG. 5 shows an example map 300 that illustrates, for example, various roadways, charge devices, and accommodations that may be accessible to a motor vehicle 310 (which is represented at its current location). Depending on the circumstance, the user may be in the motor vehicle 310 (e.g., as a driver or passenger) or the user may be remote from the motor vehicle 310 (e.g., for assisting the driver and/or trip planning). In this regard, the map 300 may be presented to a user via a display (e.g., with reference to FIG. 18, display 122 of the motor vehicle, display 182 of a user device such as a user's smartphone, or other display). Currently the motor vehicle 310 is traveling down an interstate (I7) 302 that has various upcoming exits 308a, 308b, and 308c. As an example, exit 308b corresponds to roadway 303.

The map 300 also illustrates various charge devices 350a-350j (which are represented at their corresponding locations on the map 300). The map 300 also displays various accommodations (e.g., Coffee Shop A 376, rest stop 372, etc.) on the map 300 (which are represented at their corresponding locations). Some example accommodations include parks (e.g., park 370), recreation activities (e.g., tennis 392), campgrounds (e.g., campground 391), coffee shops (e.g., Coffee Shop A 376, Coffee Shop B 379), rest stops (e.g., rest stop 372), restaurants (e.g., Restaurant A 374a, Restaurant B 374b), gas stations (e.g., Gas Station A 378), service stations, greenways, grocery stores, delivery drop off points, among any other service or good provider.

In many cases, one or more accommodations may be located nearby a charge device (e.g., at the same location, within a distance threshold (e.g., within 0.5 miles, within 0.25 miles, etc.)). In some such cases, those one or more accommodations may be considered to be “associated” with the charge device with respect to various recommendations and features herein, such as may be provided by the recommendation/feature module 220. Some example charge devices and their associated accommodations are illustrated on the map 300 in FIG. 5. For example, charge device 350a does not have any nearby accommodations that are associated with it, whereas as both charge device 350b and charge device 350c are located at a rest stop 372 and, thus, the rest stop 372 is associated with either charge device 350b, 350c. Charge device 350d is located nearby (e.g., at the same location as) Coffee Shop A 376, such that Coffee Shop A 376 is associated with charge device 350d. Similarly, Restaurant A 374a is associated with charge device 350e and Restaurant B 374b is associated with charge device 350f. The park 370, and the corresponding recreation activity of tennis 392, campground 391, and point of interest of a lake 393, may all be associated with charge devices 350g and 350h. Such charge devices 350g, 350h may be considered at the same location of the park and/or nearby the park (e.g., within a distance threshold). Coffee Shop B 379a may be just outside the distance threshold of, for example, 0.1 miles, of charge device 350i, such that charge device 350i does not have any accommodations associated with it. Whereas, Coffee Shop C 379b may be within the distance threshold of, for example, 0.1 miles, such that it is associated with charge device 350j. Charge device 350j may also be associated with Gas Station A 378, which is at the same location. In this regard, there may be multiple accommodations associated with a charge device, or multiple charge devices associated with an accommodation.

The above examples describe use of a distance threshold for determining whether an accommodation is associated with a charge device. In some embodiments, the distance threshold may be preset. Additionally or alternatively, the distance threshold may be set by a user (or dynamically determined, such as based on user preference data). In some embodiments, different types of accommodations may have different distance thresholds. For example, coffee shops may have a distance threshold of 0.25 miles, whereas restaurants may have a distance threshold of 0.5 miles. Such an example may indicate that a user is willing to walk a little further for a restaurant while their motor vehicle is charging.

In some embodiments, other types of accommodations are contemplated, such as potential transportation options available at or near a charge device (e.g., buses, scooter rentals, bike rentals, commuter trains, etc.). In some embodiments, delivery optionality may be considered an accommodation for a charge device (e.g., certain coffee shops may deliver to certain charge devices, etc.).

Various embodiments of the present invention contemplate providing recommendations and features regarding charging or operating an electric motor vehicle. In this regard, in some embodiments, a user may select (such as via map 300) one or more charge devices to be presented with data (including a recommendation or feature) regarding the selected charge device. Additionally or alternatively, a user may request (e.g., select) that the system provide a recommendation of a charge device or a recommendation about a selected charge device (or perform any other function or feature described herein). In some embodiments, there may be no selection and the system may automatically determine to provide a recommendation or feature. In some cases, such automatic determination may occur once something is triggered, such as a threshold amount of charge remaining in a battery (e.g., if the charge drops below 10% (or other threshold percentage 35%, 25%, etc. or drops below an amount of estimated travel distance range remaining—such as 10 miles, 50 miles, etc.). In some embodiments, the systems and methods may be run dynamically as the motor vehicle travels, causing updates to the recommendation or feature in real time. In some embodiments, the system may dynamically determine the threshold for triggering the recommendation determination, such as if there are only a limited number of charge devices (e.g., 3 or less, 1 or less) and/or the nearest charge device (or next nearest after that) along the current route is so far away (e.g., 50 miles, 10 miles, etc.).

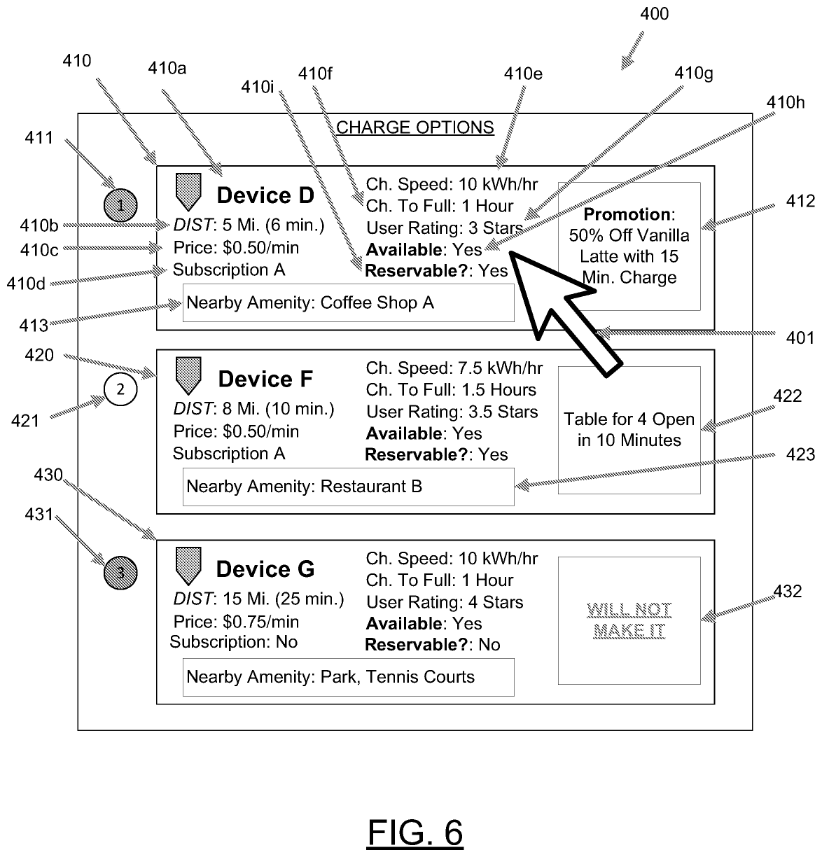

FIG. 6 illustrates an example screen 400 that may be presented to the user for recommending charge devices to utilize in charging the battery of their motor vehicle. Such a screen may be presented to a user via a display (e.g., with reference to FIG. 18, display 122 of the motor vehicle, display 182 of a user device such as a user's smartphone, or other display). In some embodiments, recommended one or more charge device(s) may be determined and presented to a user in response to a user request, dynamically as the user travels, automatically as the user travels, or otherwise as noted above. Further, although the screen 400 is described as being presented for providing recommended charge device options, some embodiments of the present invention contemplate portions of what is presented on the screen 400 being presented in response to, for example, a user selecting a charge device. For example, the charge device information for Charge Device D 410a (e.g., corresponding to charge device 350d in map 300) and promotion 412 may be presented on its own when a user selects (e.g., clicks on, hovers over, etc.) the icon on map 300 corresponding to charge device 350d. Such a presentation flow may be operative with various example embodiments described herein.

Returning to FIG. 6 and the screen 400 of recommended one or more charge device options, the system (e.g., via the recommendation/feature module 222) has determined three charge device options to present. Such recommendations may be formed using the various factors (and, perhaps, weights) as detailed herein, such as via the recommendation/features module 222. The recommendations may correspond to recommended charge devices based on various circumstances regarding operation of the electric motor vehicle and may lead to an easier and more user-friendly experience for selecting a charge device to use for recharging the battery of the motor vehicle. Such a feature also removes significant research that would otherwise need to occur by the user to select a charge device, which avoids wasted time by the user and provides a safer, more pleasant driving experience (e.g., the user or passenger may feel rushed to otherwise research and pick a charge device as they drive).

The first recommended charge device 410 on screen 400 is Charge Device D 410a. which may correspond to charge device 350d on map 300 in FIG. 5. The system may assign a recommend number or value 411 that may also be color coded to indicate the desirability of the recommend charge device 410 (e.g., the number 1 and the color green). The screen 400 also includes various charge information regarding Charge Device D 410a, such as the distance to the charge device 410b from the current location of the motor vehicle (e.g., 5 miles, which has an estimated travel time of 6 minutes); a price associated with use of the charge device 410c (e.g., $0.50 per minute of use); a subscription indication 410d (e.g., this charge device offers use with Subscription Plan A); a charge speed of the charge device 410e (e.g., 10 kWh per hour); an estimated time to full charge of the motor vehicle battery 410f (e.g., 1 hour); a user rating 410g (e.g., 3 stars out of 5 stars); an availability status 410h as to whether the charge device is either currently available or will be available at the estimated time of arrival (e.g., “Yes”); an indication as to whether the charge device accepts reservations 410j (e.g., “Yes”); and an indication of a nearby associated accommodation 413 (e.g., nearby amenity of Coffee Shop A (corresponding to Coffee Shop A 376 from map 300)).

In order to determine the various charge information, the system takes into account various types of data, such as indicated above with respect to the recommendation/feature module 222. Further, in order to determine if Charge Device D is one of the recommended charge devices, the system takes into account various types of data including the user preferences, such as from a user profile or otherwise determined (as detailed above with respect to the recommendation/feature module 222). For example, the current motor vehicle data (including the current location of the motor vehicle, the current amount of charge remaining in the battery, among other data); charge device data (including the location of the charge device, the current availability status of the charge device, among other data), and user preference data (e.g., charge device preferences, accommodation preferences, etc.) may all be used depending on the recommendation and/or feature being determined and/or presented.

Different weights (e.g., priority or importance levels) may also be factored in to determine, for example, that Charge Device D is the preferred recommended charge device, as indicated by presenting Charge Device D first (or if Charge Device D is the only one presented) and/or via the recommended number or value 411. Notably, the user may have a user preference for coffee from Coffee Shop A and so the recommendation/feature module 222 determined that Charge Device D, which is associated with Coffee Shop A was the preferred recommended charge device option. Additionally, however, the relative distance to Charge Device D (and/or other factors) in comparison to other charge device options (even with user preferred associated accommodations) may have been considered when arriving at the recommendation for Charge Device D. For example, the second recommended charge device 420 is Charge Device F (which corresponds to charge device 350f in map 300), as indicated by the recommended number and value 421 (e.g., the number 2 and yellow). The user may have a preference for eating at Restaurant B (shown at 423) which is associated with Charge Device F, but one or more other factors may have caused the system to recommend Charge Device D over Charge Device F—such as an increased distance to the charge device (e.g., the extra 3 miles to Charge Device F as compared to Charge Device D may not have reached a determined difference threshold to cause recommendation of Charge Device F over Charge Device D) or a reduced charge speed relative to Charge Device D. In this regard, similar thresholding methods may be applied to other factors as described herein (and any factors could be utilized in the recommendation(s))—e.g., relative pricing, relative charge speed, relative subscriptions, relative associated accommodations, any nearby accommodations, relative user ratings, relative safety ratings, if and/or what lighting is available for the charge device(s), offers or promotion data, how many plug charge devices are offered, size and/or shape data regarding the parking spaces, effects of weather regarding access to the charge devices, usage data (e.g., how often is the charge device used, etc.), the type of charge plugs, if any charge plug adapters are available and/or which ones are available, if any battery swap(s) are available, the type of battery swap(s) available, number of battery swap(s) available, among other types of data corresponding to the charge devices).

In some cases, the amount of charge remaining in the battery may play a factor in the recommendation. For example, the third recommended charge device 430 is Charge Device G (which corresponds to charge device 350g in map 300), as indicated by the recommended number and value 431 (e.g., the number 3 and red). Here, the system may have determined that current amount of charge in the battery of the motor vehicle may not make it to the charge device, as indicated by the message in red “Will Not Make It” 432. This may be because the distance to the charge device is 15 miles and the system may determine that there is only an estimated travel distance range remaining of 10 miles. In some cases, the system (such as via user selection or otherwise) may have a minimum estimated travel distance range remaining, such that even if the current amount of charge remaining could cause the motor vehicle to make it to the charge device, the user may not want to take that chance and prefer to have a little charge remaining on arrival, such as for peace of mind (e.g., an extra 5 estimated miles, 1 estimated mile, etc.).

In some embodiments, the system may be configured to determine and present one or more recommendations or features associated with a charge device. For example, this may occur in response to a user selecting a charge device and/or as part of another recommendation/feature (e.g., recommending charge device options, such as shown in FIG. 6)—including automatically (and, in some cases, dynamically) as the user is traveling.

FIG. 6 illustrates an example determined offer or promotion 412 associated with use of Charge Device D. In this regard, the system has determined and presented an offer or promotion 412 of “50% Off Vanilla Latte with 15 Min. Charge”. Such an offer or promotion 412 may be determined based on user preference data and/or may be designed to encourage the user to utilize the charge device and/or the corresponding service provider (e.g., Coffee Shop A). In some embodiments, the offer or promotion may be tied to usage of the charge device. Additionally or alternatively, the offer or promotion may not be tied to usage of the charge device and may, instead, be related to the service provider offering services at or near the charge device (e.g., Coffee Shop A is within 0.1 miles of Charge Device D). In some embodiments, the available offers or promotions may be taken into account when deciding which charge devices to recommend (such as based on user preference data). Notably, other types of offers and promotions are contemplated.

FIG. 6 also illustrates another example recommendation or feature that may be presented to the user in the form of information about an associated accommodation. In this regard, the system has determined that there is an open reservation for 4 people in 10 minutes at Restaurant B. Accordingly, since Restaurant B is associated with Charge Device F, the system may present such an indication to the user when presenting information about Charge Device F. For example, the system has presented “Table for 4 Open in 10 minutes” at 422. Notably, in some embodiments, the system may factor in the estimated travel time it will take for the motor vehicle to arrive at the charge device when looking for available reservations. Notably, offering user preferred restaurant options is a great fit for occupying the user on a trip while their electric motor vehicle recharges. Such a feature attempts to negate or minimize the impact of longer recharge times for electric vehicles by combining the recharge time with a user preferred activity—all without the user needing to plan ahead, which is a benefit of various embodiments described herein.

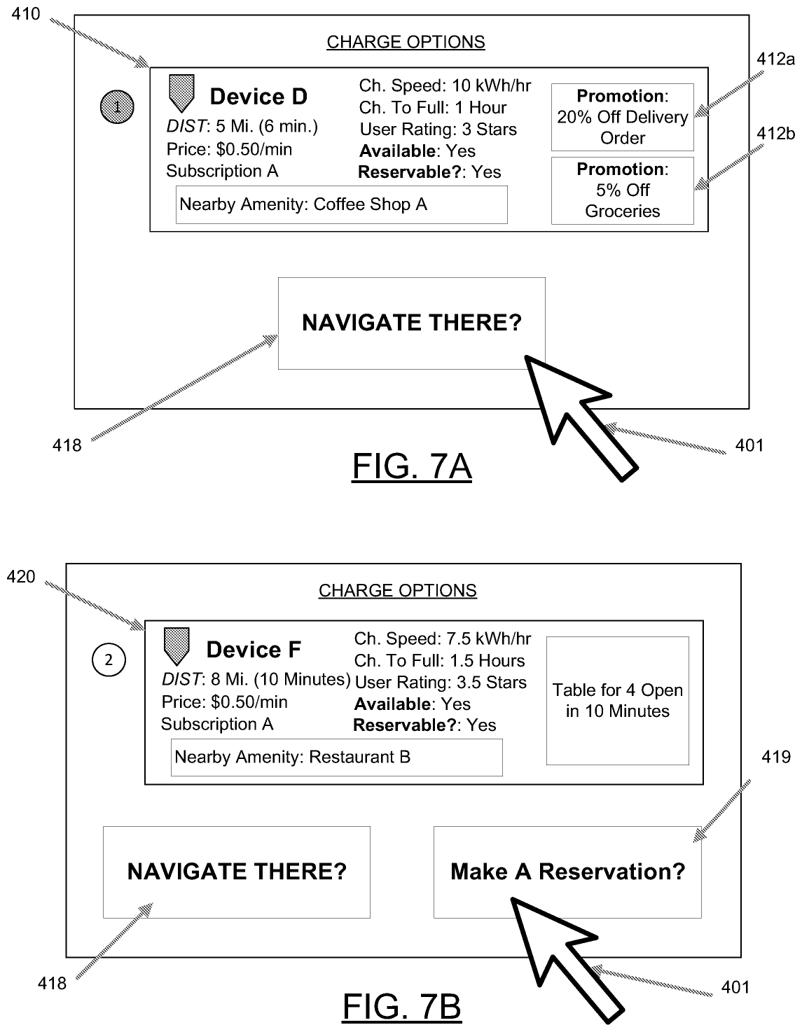

Upon selection of a charge device, such as either via map 300 or by selecting one of the recommended charge device options (e.g., a user 401 has selected the first recommended charge device 410), the system may present one or more features related to the selected charge device. FIGS. 7A-B illustrate example selectable options that may be presented to a user upon selection of a charge device (although, in some embodiments, the selectable options may be presented initially without further selection required, such as part of the presented recommended one or more charge devices in FIG. 6). Turning to FIG. 7A, the system has presented a selectable option of Navigate There? 418. In this regard, upon the user 401 selecting the Navigate There? 418 option, the system may cause a navigation system to prepare a route that will take the motor vehicle to the corresponding charge device (e.g., Charge Device D). For example, the system may determine a route that the user can follow to arrive at the charge device. In some embodiments, an autopilot can be engaged to cause the motor vehicle to travel along the route to the charge device. Turning to FIG. 7B, the system has presented a selectable option of Make a Reservation? 419. In this regard, upon the user 401 selecting the Make a Reservation? 419 option, the system may cause a reservation request to be initiated and/or made at Restaurant B, which is associated with Charge Device F. In this regard, the system, for example, may utilize an online reservation system to make the reservation, could initiate call to the restaurant, or supply the user with a number of the restaurant to enable the user to call the restaurant for creating the reservation. Although the above describes examples of “Navigate There” and “Make A Reservation”, other similar types of features are contemplated, such as “Pay Now” for purchasing charge device space and/or time, “Reserve” for reserving the charge device, “Order Now” for ordering something from an accommodation associated with the charge device, among many other feature options.

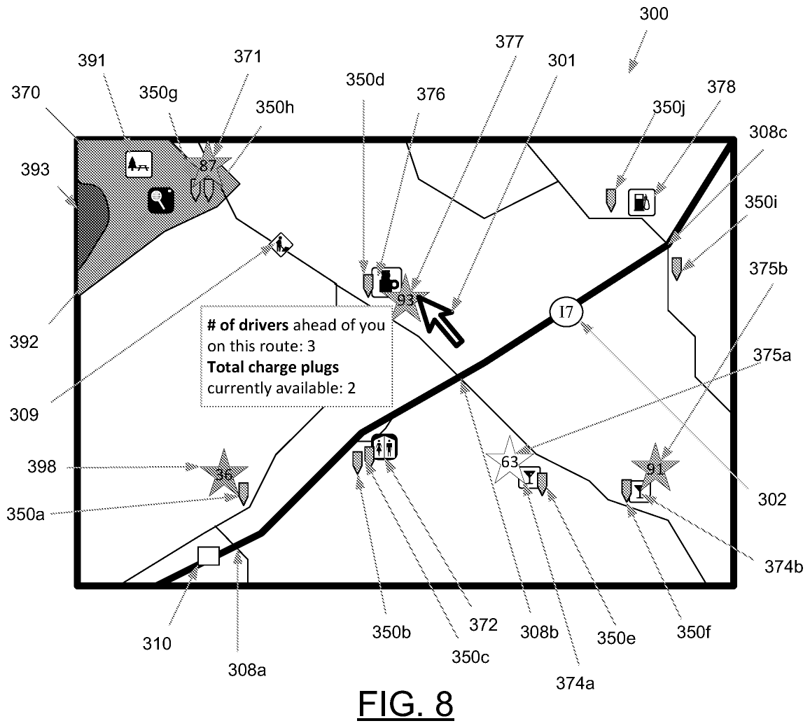

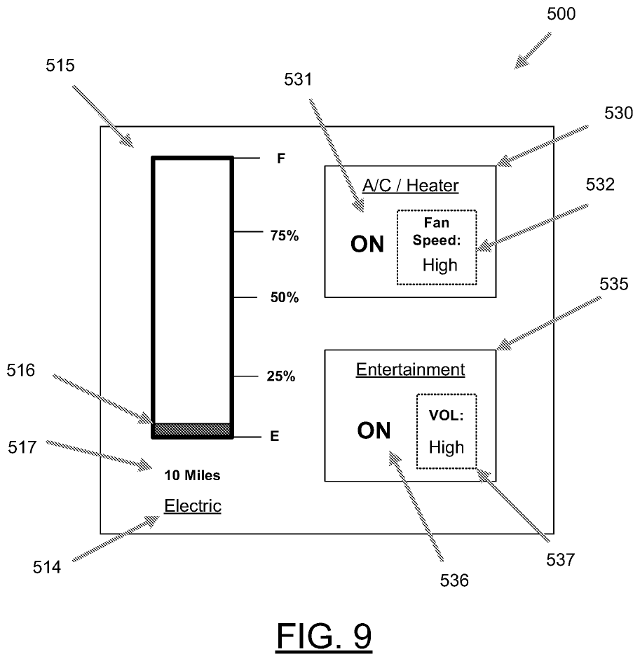

In some embodiments, the system may be configured to present one or more recommendations or features directly on the map 300. For example, with reference to FIG. 8, the system has presented recommendation indicators regarding one or more of the charge devices. The recommendation indicators may provide an indication of the desirability level of using the charge device, such as based on user preference data, charge device data, and/or motor vehicle data (such as described herein). For example, the charge device 350a has a recommendation indicator 398 that is red and includes a value of 36 (e.g., 36% recommended), as there is no associated accommodation and there may be other factors that are not as desirable (e.g., lighting available, safety rating, etc.). As an aside, for example, the system may take into account the time of day and apply that to certain weighted factors. For example, at night, a lighting rating for a charge device may be very important (e.g., to ensure that there is sufficient light for the user to feel safe while charging). As an example here, it may be dark outside at the estimated time of arrival at charge device 350a and the lighting rating may be 0, indicating that there is no overhead light available, which may cause the recommendation indicator to be so low. Turning back to more examples, charge device 350d has a recommendation indicator 377 that is green and a 93, which corresponds to prior description of the recommended value of charge device 350d. In comparison, charge device 350h has a recommendation indicator 371 that is green and an 87, which is less than 93 and, thus, charge device 350d was recommended in FIG. 6 first. Turning to charge device 350f, it has a recommendation indicator 375b that is green and a 91, which can be compared with charge device 350e which has a recommendation indicator 375a that is yellow and a 63. This may be an example of where both charge devices 350e and 350f have restaurants associated with them, but Restaurant B 374b is preferred by the user over Restaurant A 374a. Thus, even though charge device 350e is closer to the motor vehicle, charge device 350f is more preferable and, thus, the recommendation indicator is higher.

In some embodiments, the system may present information related to a charge device in a pop-up form. For example, if a user selects (e.g., clicks on, hovers over, etc.) a charge device (e.g., charge device 350d), the system may determine various information related to the charge device and/or travelling to the charge device. For example, the system may determine that there are 3 drivers of electric motor vehicles ahead of you on the way to the selected charge device (such that they may be competition for using the charge device). Other potentially useful information is how many plugs of the charge device are currently available—in this case 2. In some embodiments, a relative traffic indicator could be provided. For example, if the user selected charge device 350h, they may be curious why the estimated travel to the charge device is longer than expected and an indication of traffic or construction 309 along the route may be indicated. In some embodiments, as detailed above, such traffic or construction data may be factored into the various recommendations and features provided herein (e.g., the recommendation indicator 371 of charge device 350h may otherwise be higher than 87 if not for the traffic/construction 309 along the way there).

In some embodiments, as noted herein, the system may be configured to determine current motor vehicle data. For example, the system may be configured to determine a current amount of charge remaining in an engine battery. The system may also be configured to determine operating characteristics of the various systems/devices onboard the motor vehicle. In some embodiments, the system may be configured to determine a power draw on the engine battery based on one or more systems/devices of the motor vehicle. FIG. 9 shows an example display screen 500 illustrating an amount of charge remaining in an engine battery 515, along with operating characteristics of two example systems on the motor vehicle, namely the air conditioner (A/C)/Heater (although any temperature element and/or fan is contemplated) 530 and the entertainment system 535.

The screen 500 details that the current amount of charge remaining in the engine battery 516 for the electric engine 514 is well below 25%, such as around 8% charge remaining. Notably, the system has determined that the current amount of charge remaining 516 correlates to an estimated travel distance range remaining of about 10 miles, which is displayed at 517. The screen 500 also shows certain operating characteristics of the A/C/Heater 530. In particular, it shows that that A/C/Heater is “On” at 531 and that the fan speed is set to “High” at 532. Similarly, the screen 500 shows certain operating characteristics of the entertainment system 535. In particular, it shows that the entertainment system is “On” at 536 and the volume is set to “High” at 537.

In some embodiments, the motor vehicle may be configured such that one or more additional systems/devices, such as the A/C/Heater and/or entertainment system, may draw power from the same battery that provides electrical energy to the engine for operating the motor vehicle. In this regard, such one or more additional systems/devices may cause power draw on the battery which may affect how far the motor vehicle can travel on the current amount of charge remaining. For example, if the A/C/Heater is on high fan speed, there may be more power draw on the battery than if the A/C/Heater is on low fan speed or not operating at all—and this additional power draw may result in the motor vehicle not being able to travel an extra distance (e.g., an extra 2 miles, 5 miles, etc.). This may similarly be true for other additional systems/devices of the motor vehicle such as the entertainment system, although other systems/devices are contemplated (e.g., lighting, cigarette burner, phone charger, USB ports, wireless communication network operation (e.g., WiFi in the motor vehicle), etc.). Notably, the system may be configured to determine such power draw and account for that power draw from the additional systems/devices when determining the estimated distance range remaining (e.g., 10 miles as presented at 517).

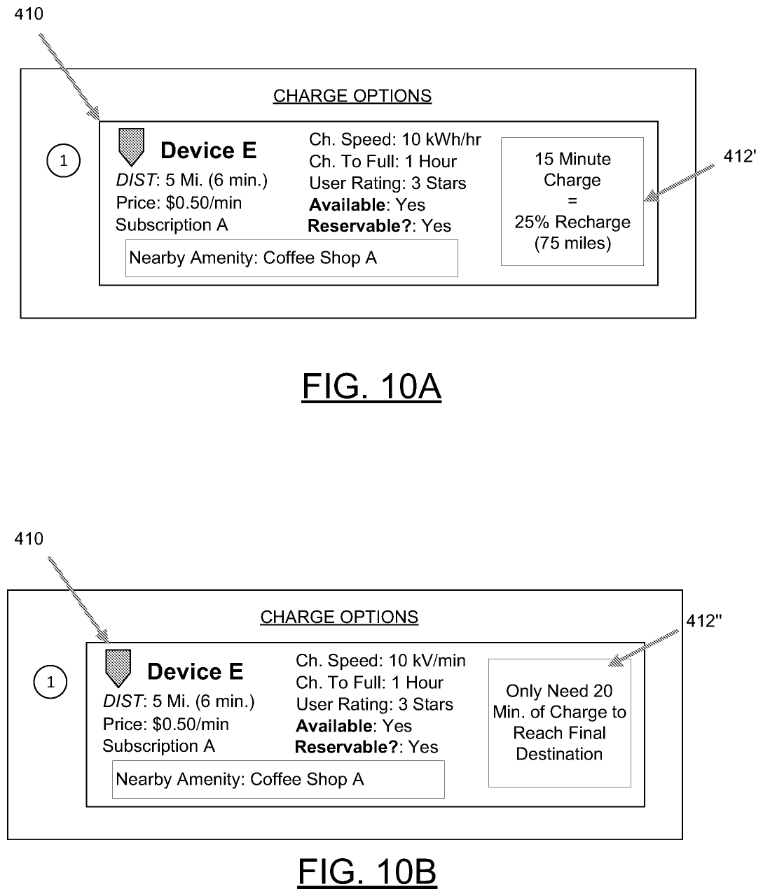

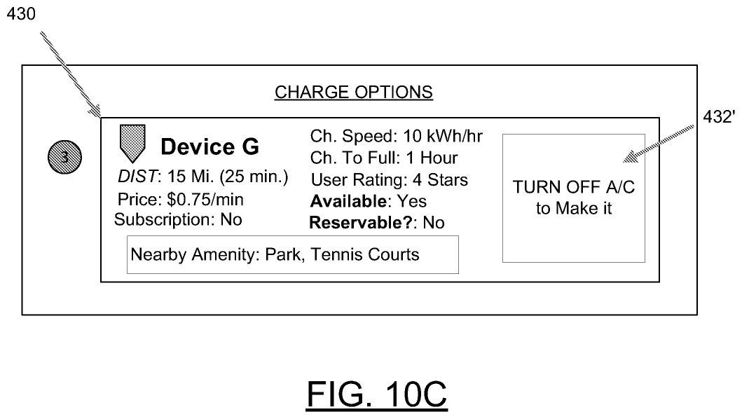

As noted herein, in some embodiments, the system may be configured to determine and provide various recommendations or features regarding charge devices. FIGS. 10A-C illustrate some example recommendations or features regarding various charge devices. Such recommendations or features may take into account the various data noted herein, such as used in the recommendation/feature module 222.

In some embodiments, the system may be configured to determine a recommended amount of time to use a charge device to charge the battery. FIG. 10A illustrates a recommendation 412′ for Charge Device D 410 that the user may want to consider using Charge Device D for 15 minutes to recharge the engine battery 25%, which would provide an additional 75 miles. In this regard, by using the current motor vehicle data, such as the current amount of charge remaining and various current operating characteristics that enable determination of an estimated distance range remaining, and the charge device data, such as the charge speed of the charge device, the system may determine an optimal or recommended amount of time for the user to spend charging to receive a desirable amount of charge. In some embodiments, this may be determined by the system to correlate to an estimated amount of time a user may typically spend at an associated accommodation (e.g., 15 minutes at Coffee Shop A)—and, thus, the system may determine to recommend that amount of time. Additionally or alternatively, the system may use other data, such as current or future route data to determine how much charge is needed to reach a final destination (or a next desirable charge device) and working backward, could recommend an amount of time to spend charging the battery. This could lead to a desirable trip where the user is presented with time linked accommodations that the user enjoys while getting enough charge to make it to the next charge device (and next time linked desirable activity) or the destination. Notably, the system may also take into account whether there is an expected charge device at the destination when determining which charge devices to recommend and/or how long to charge at them. For example, FIG. 10B illustrates a recommendation 412″ that indicates that only 20 minutes of charge is need to reach the final destination.

In some embodiments, the system may be configured to determine and recommend adjustments to make to one or more additional systems/devices of the motor vehicle, such as to improve operation of the motor vehicle and/or elongate the estimated travel distance range remaining. FIG. 10C illustrates a recommendation 432′ for reaching Charge Device G 430 that the user may want to consider regarding adjusting one or more additional systems/devices of the motor vehicle to enable the motor vehicle to make it to the charge device. For example, returning to FIG. 6, the system originally determined that the motor vehicle would not make it to Charge Device G based off the current battery usage and the current amount of charge remaining on the battery. Returning back to FIG. 10C, the system has determined that it can increase the estimated travel distance range remaining up to at least the 15 miles it would take to reach the Charge Device G by having the user turn off the A/C. In this regard, saving the additional power draw on the battery from operation of the A/C over that time period (e.g., traveling to the charge device) has been determined to be sufficient to result in the increased estimated travel distance range remaining to enable the motor vehicle to reach the charge device. Accordingly, that recommendation has been made to the user. Along these lines, in some embodiments, the system may be configured to make various recommendations about potential adjustments to make to operation of one or more additional systems/devices to result in revised charge usage of the battery. In some embodiments, the corresponding recommendations in adjustments may relate to recommended charge devices or destinations, such that the user can decide if they don't mind adjusting the operation of the additional systems/devices in order to enable reaching the charge device and/or destination.

In some embodiments, the system may be configured to determine if one or more of the additional systems/devices are drawing too large of an amount of power from the battery, such as due to potential unnecessary operation or a fault. The system, for example, may compare a current power draw associated with an additional system/device to an expected power draw and based on the difference, the system may determine such a circumstance and may make a corresponding recommendation of adjustment to the user.

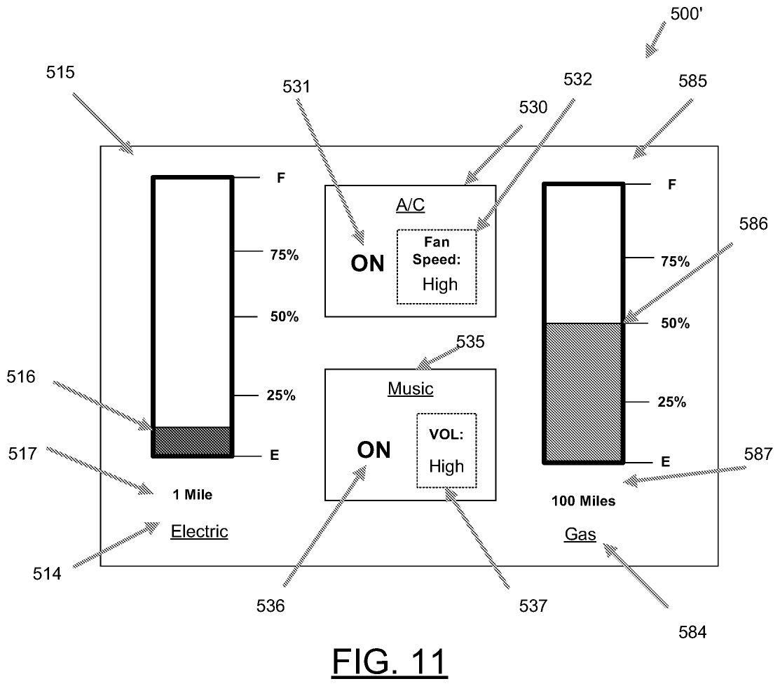

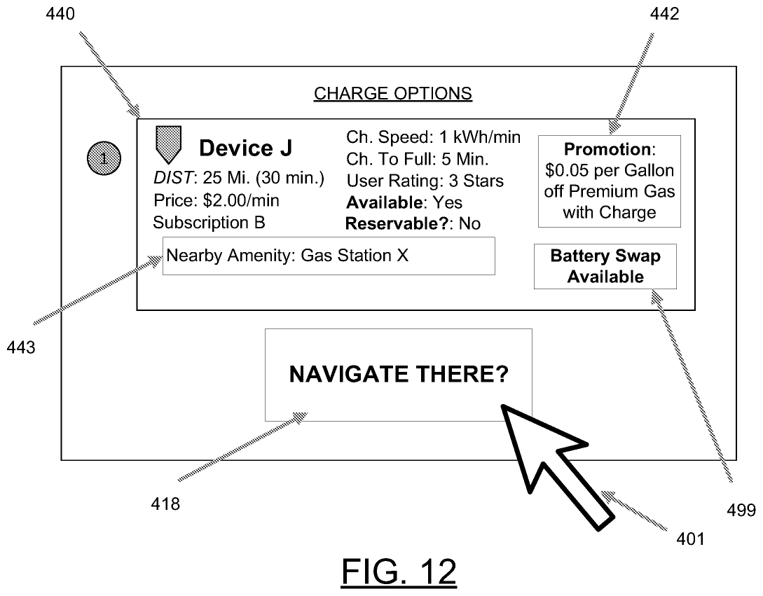

As noted herein, in some embodiments, the system is configured to work with hybrid motor vehicles that may also use fuel to run an engine in the motor vehicle. In this regard, FIG. 11 illustrates an example display screen 500′ that further shows the amount of fuel remaining in the fuel tank 585 for the gas engine 584 (although other types of fuel are contemplated). The current amount of fuel remaining 586 is about 50% remaining. Notably, the system has determined that the current fuel remaining 586 correlates to an estimated fuel travel distance range remaining of about 100 miles, which is displayed at 587. Accordingly, the system may be configured to factor in the need for fuel and or use the estimated fuel travel distance range remaining in connection with any recommendations or features described herein. For example, the motor vehicle may be able to reach a charge device further away using fuel (e.g., after the electric engine battery is depleted). In some embodiments, the system may determine to recommend charge devices located at gas stations when fuel is needed as well. Further, there could be promotions that involve gas and electric charging that could be determined for recommendation. For example, FIG. 12 illustrates an example recommendation for Charge Device J 440 that includes a promotion 442 corresponding to filling up on gas and using a charge device. Notably, the nearby amenity of Gas Station X may be presented at 443. There is also a selectable option 418 that causes navigation to the charge device to occur upon selection by the user 401.

In some embodiments, the system may be configured to determine an offer or promotion to present to a user that is specifically tailored to the user, so as to encourage the user to utilize the charge device and/or service provider advertising with the charge device (e.g., a service provider for an accommodation associated with the charge device). In this regard, the system (e.g., via the recommendation/feature module 222) may be configured to consider various data, including, for example, user preference data, current motor vehicle data, or other data, for aiding in determining which offer or promotion to provide to the user. For example, the system may determine a plurality (e.g., a list) of offers or promotions that can be applied to a charge device being presented to a user. The system may be configured to determine a likelihood of each available offer or promotion from the plurality of offers or promotions to drive the user to utilize the charge device and/or service provider corresponding to the offer or promotion, such as based on various data, including, for example, the user preference data, current motor vehicle data, etc. Then, the system may be configured to select the available offer or promotion that is most likely to cause the user to utilize the charge device and/or service provider. For example, the system may determine from among three offers, where a first offer is for 10% off groceries at a nearby supermarket, a second offer is for 25% off a Latte at a nearby coffee shop; and a third offer is for buy one get one free windshield wipers. Depending on the user preference data and/or current motor vehicle data, the system may select to use the first offer (e.g., because the user is near the destination and might need groceries for the rental house), the second offer (e.g., because the user likes Latte's), or the third offer (e.g., because the current motor vehicle data indicates that the user's motor vehicle needs new windshield wiper blades). The system may assign weights or priorities to help make the decision between offers. In the instant case, for example, the system may determine that it is rainy outside and, thus, the system may prioritize the third offer. However, if it is not rainy and it is late at night, the system may prioritize getting the user some coffee to help them stay awake on the road. As another example, the system may determine that a recommend length of usage of the charge device corresponds with how long a typical grocery shop takes and, thus, may select that offer. In this regard, any number of various factors and data can be used by the system to provide beneficial and desirable offers or promotions to the user.

In some embodiments, the system may be configured to keep track of which offers or promotions are most successful and provide that information to the charge device provider and/or service provider for consideration of future offers or promotions. In some embodiments, the system may track which offers or promotions are most successful for helping determine future offers or promotions to select for providing to the user (e.g., offers or promotions that are similar to the successful offers or promotions).

Returning to FIG. 12, some embodiments of the present invention also contemplate various recommendations and features that may include battery swaps. For example, if the motor vehicle engine battery is so configured for swapping, the system may look for such availability when recommending locations to stop (e.g., to swap the battery, such as instead of charging the battery) and present it to the user, such as at 499 in FIG. 12.

In some embodiments, the system may be configured to determine and provide a visual indication to the user of the estimated travel distance range remaining for the motor vehicle. In this regard, the system, such as via the recommendation/feature module 222, may be configured to gather and utilize various data for performing such a feature. In some cases, an estimated distance of mileage can be helpful, but it can still be difficult for user to easily determine where that would actually allow a user to reach with their current amount of charge in the battery. Moreover, the generic mileage estimate does not take into account the specifics of each route that could be travelled, such as traffic, hills, engine efficiency, etc. Accordingly, in some embodiments, the system is configured to determine possible locations a user could reach on the current amount of charge remaining and generate an overlay or other indication to present on a map to visually indicate the estimated travel distance range remaining to the user from their current location. In some embodiments, the system may be configured to determine where the user could reach along each possible route that the user could take and generate the overlay accordingly. Although the term overlay is used for some example embodiments described herein, the term is not meant to be limited to being only an overlay, as, for example, in some embodiments, the system may generate the map with such indications (e.g., line(s), dot(s), shading, patterned dots, etc.) built-in as part of the same “layer”.

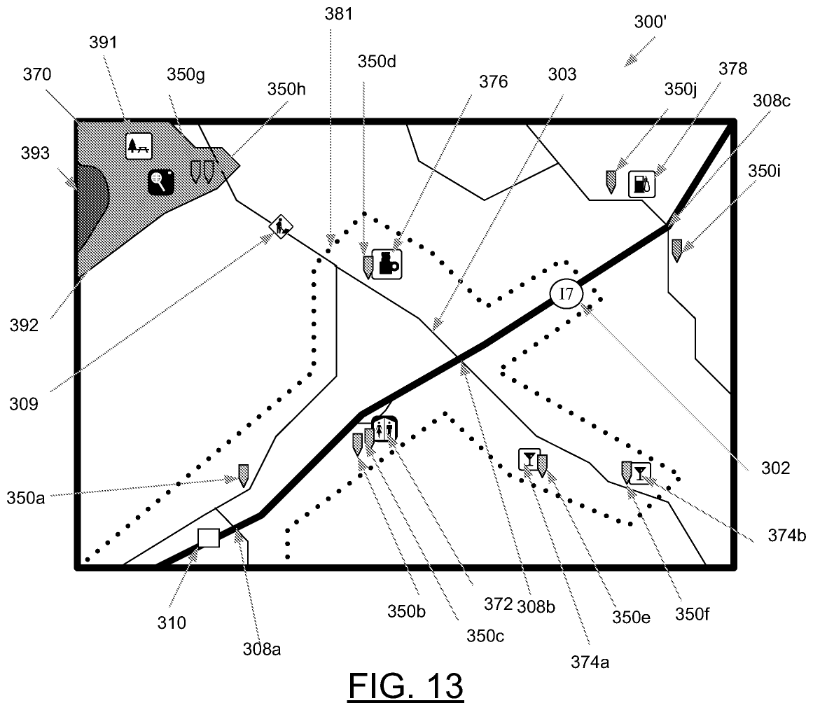

FIG. 13 illustrates an example map 300′ with an estimated travel distance range remaining indicator 381 in the form of a dotted line that is presented as an overlay on the map. In this regard, depending on the set-up, the system may determine and present an overlay indicating the estimated travel distance range remaining in response to user input, automatically, or otherwise. FIG. 13 illustrates a dotted line as the estimated travel distance range remaining indicator 381 (although other types of indicators are contemplated, such as one or more solid lines, shading, patterned dots, etc.). In some embodiments, the estimated travel distance range remaining indicator may be updated dynamically as the user travels, such as roadway conditions change, the current amount of charge remaining changes, the current power draw from various systems/devices of the motor vehicle changes, among other things.

As illustrated in FIG. 13, the system may account for specifics of potential routes that the motor vehicle may travel along from its current location 310. For example, the motor vehicle may be able to travel further in distance on the interstate I7 302, but not as far on the roadway 303. For example, the traffic or construction 309 may limit how far the motor vehicle could travel, such as toward the park 370. Notably, the estimated travel distance range remaining indicator may also account for and show buildings, structures, parks, etc. that can be reached from the roadway where the user is able to travel to. In this regard, the user can easily see that, for example, they can reach Restaurant B 374b on their current charge in their motor vehicle. This can be further reinforced by some coloring or highlighting of various reachable or unreachable icons on the map 300′. For example, charge device 350f is blue, whereas charge device 350i is red (indicating that it is unreachable on the current amount of charge remaining in the battery).

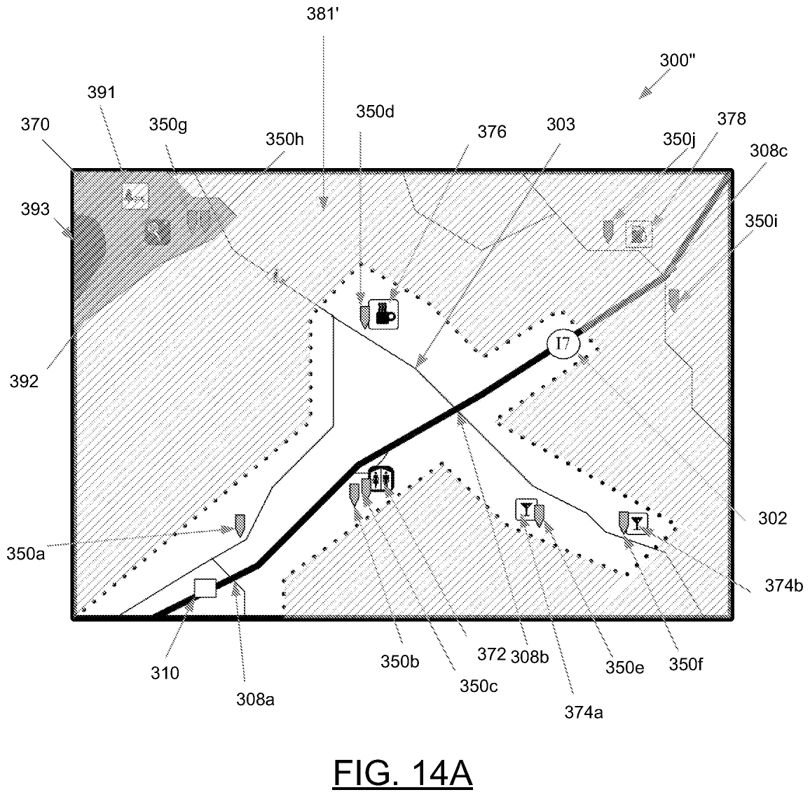

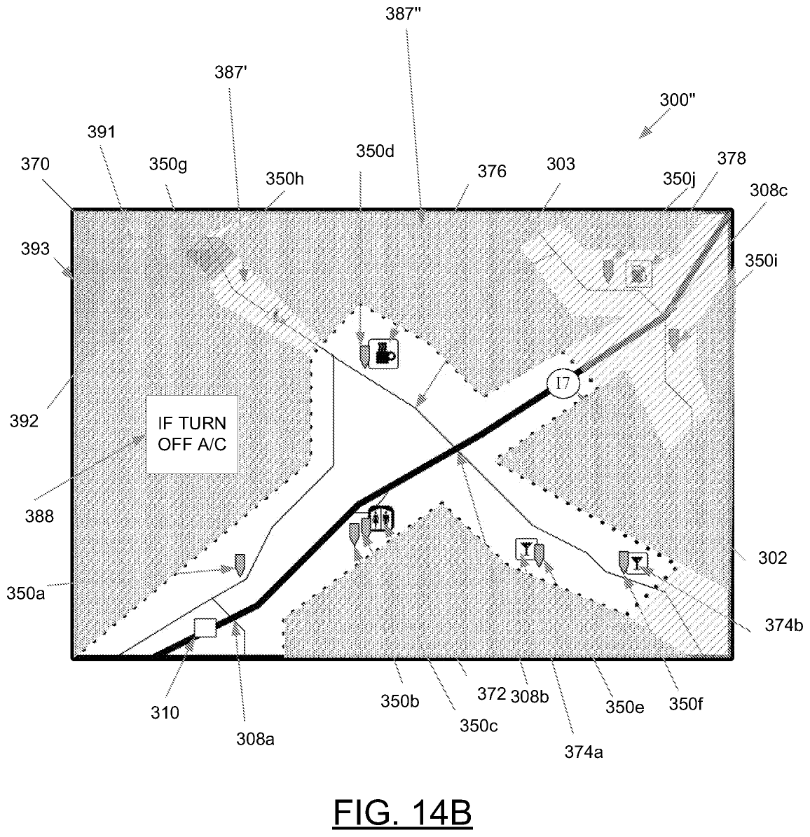

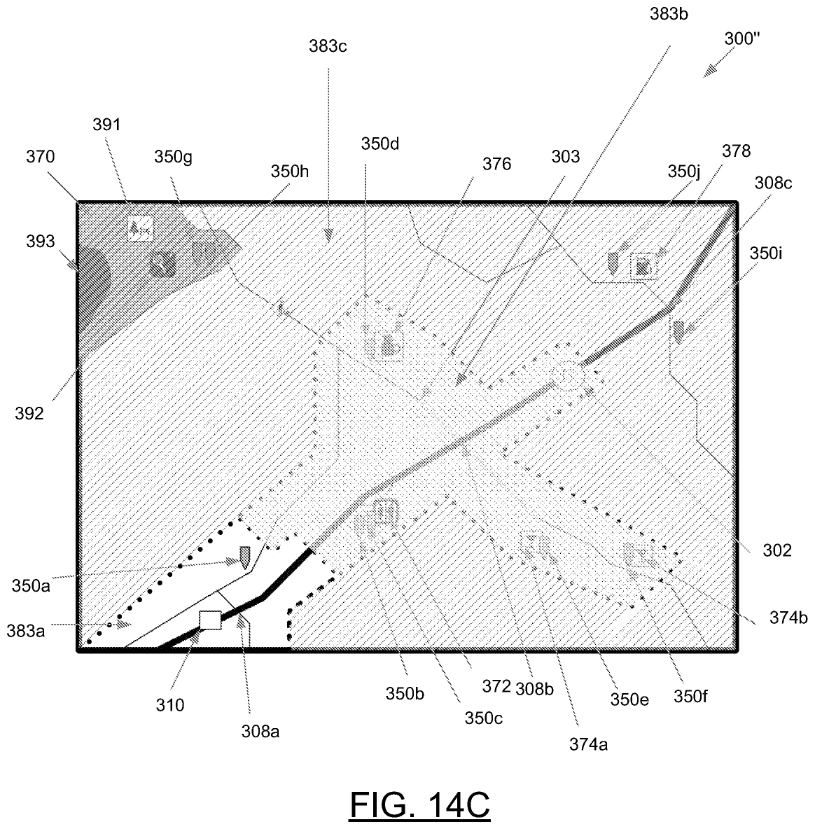

FIGS. 14A-C illustrate further examples of various overlays and their corresponding determinations by various example embodiments.

FIG. 14A illustrates that the estimated travel distance range remaining indicator 381′ could be shading that is applied to unreachable locations on the map 300″. While a shaded pattern is illustrated, other types of shading, coloring, etc. could be utilized.

As detailed herein, in some embodiments, the system may be configured to determine potential adjustments that could be made to operation of one or more additional systems/devices of the motor vehicle to adjust the estimated travel distance range remaining. Accordingly, in some such embodiments, the system may be configured to provide a preview of or an updated view of the estimated travel distance range remaining indicator on the map. This could include an additional overlay, an updated overlay, or other similar form. For example, FIG. 14B illustrates a map 300″ that includes a first estimated travel distance range remaining indicator 387′ that is similar to what is shown in FIG. 14A (e.g., the red pattern shading), but also includes a second estimated travel distance range remaining indicator 387″ that is a darker grey shading that covers less of the map 300″. Further, a pop-up message 388 indicates to the user that if they turn off the A/C then they will increase the estimated travel distance range remaining to correspond with the second estimated travel distance range remaining indicator 387″. In this regard, the system has determined that removing the power draw caused by operating the A/C results in the motor vehicle being able to reach a little further, such as to charge device 350j (which is currently unreachable with the A/C operating). Accordingly, the user is able to quickly visualize where they could go by making the adjustments noted. Such a feature could be provided in response to a user request, automatically, or otherwise and could be updated dynamically as the user travels along.

In some embodiments, the system may display layers of shading or other indications that may, for example, correspond with minimum charge thresholds for a user. For example, a darker shading could be displayed for areas that are reachable within the minimum charge threshold (e.g., reachable based on the 5% (or other determined minimum charge threshold) charge remaining).

Also as noted herein, in some embodiments, the system is configured to work with hybrid motor vehicles that also run on fuel. Accordingly, similar concepts could apply to work with a hybrid motor vehicle. For example, with reference to FIG. 14C, the system may determine a first estimated travel distance range remaining 383a where the motor vehicle can reach on the current amount of charge remaining in the battery (e.g., using full electric mode); and a second estimated travel distance range remaining where the motor vehicle can reach further using fuel. In this regard, for example, the system may present a first estimated travel distance range remaining indicator 383b that shows a light grey shading where the motor vehicle is unable to reach using the current amount of charge remaining in the battery (in full electric mode) and a second estimated travel distance range remaining indicator 383c where the motor vehicle is unable to reach using either the electric engine or the fuel consuming engine. Such a visualization may help a user determine where they can travel to if they need to use gas, for example, and allow them to make a quick and easy decision. Perhaps, for example, they are willing to use gas to reach the charge device 350d and the associated Coffee Shop A.

Alternatively, they may be willing to stop and use charge device 350a to avoid having to use gas at all. Such a feature could be provided in response to a user request, automatically, or otherwise and could be updated dynamically as the user travels along.

In some embodiments, the system, such as via the recommendation/feature module 222, may be configured to aid in trip planning. Such trip planning may include overnight stays to a final destination and/or may require the motor vehicle to charge somewhere along the way as the overall length of trip may be longer than the estimated travel distance range remaining for the motor vehicle (e.g., even on a full battery). In this regard, a current concern of electric motor vehicle owners is the ability to bring their electric motor vehicle on long trips were there is uncertainty about maintaining charge in the battery and where there is unfamiliar territory and charge device uncertainty. Further, there may even be uncertainty about whether there is a charge device that is usable at the final destination. Accordingly, some embodiments of the present invention utilize various data (e.g., motor vehicle data, user preference data, trip planning data, etc.) to recommend and assist in the creation of trip plans for the motor vehicle. With such a system, a user may be carefree in trip planning and be willing to take their electric motor vehicle on long trips, such as to the beach or the mountains (or across country). Such feature(s) could be provided in response to a user request, automatically, or otherwise and could be updated dynamically as the user travels along.

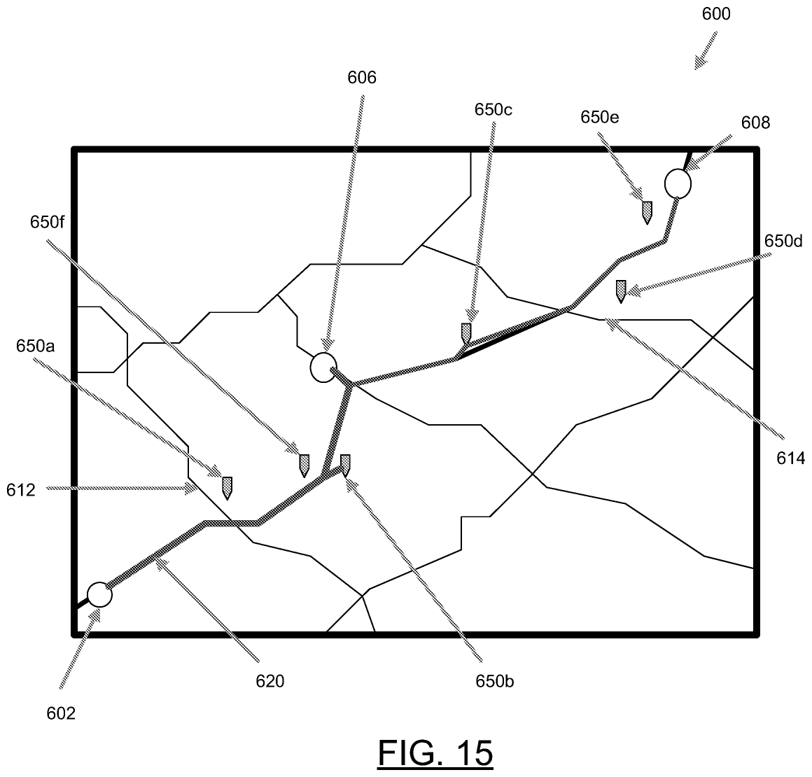

FIG. 15 illustrates an example map 600 that a user may be looking at for planning a trip from a starting location 602 to a final destination 608. The map 600 may be presented to a user via a display (e.g., with reference to FIG. 18, display 122 of the motor vehicle, display 182 of a user device such as a user's smartphone, or other display). The map 600 may present various charge devices that can be used along the way (e.g., charge device 650a off roadway 612, charge device 650b, charge device 650c, charge device 650d, charge device 650e, and charge device 650f—although there could be many more charge devices along the way). In some embodiments, the system may limit which charge devices are shown on the map or selectable based on user preferences (e.g., only charge devices that are rated 80 and above based on corresponding recommended usage (such as described above with respect to FIGS. 3-12)). The map 600 also includes an intermediate destination 606 where the user may have indicated a desire to stay, for example, overnight.

The system may be configured to generate one or more possible routes that the motor vehicle could take to reach the final destination 608, factoring in time/locations for charging as needed or desired. In the illustrated embodiment, the system has determined a route 620 that includes stopping and charging at charge device 650b, before stopping overnight at the intermediate destination 606, and then using charge device 650c before reaching the final destination 608. In this regard, the planned route 620 bypassed charge device 650a, charge device 650f, charge device 650d, and charge device 650e (likely among many others). Such a recommendation/determination of which charge devices to use along the route 620 may be based on various data, such as described above with respect to the recommendation/feature module 222. For example, charge device 650a may be too far off the route (e.g., outside a threshold distance off the route). As another example, while charge device 650f is close in proximity to charge device 650b, it may be less desirable to the user based on various data considered and, thus, the system recommended/determined use of charge device 650b. Further, the system may determine that there is no charge device present at the intermediate destination 606 and, thus, may recommend/determine use of charge device 650c soon after restarting the trip the next day.

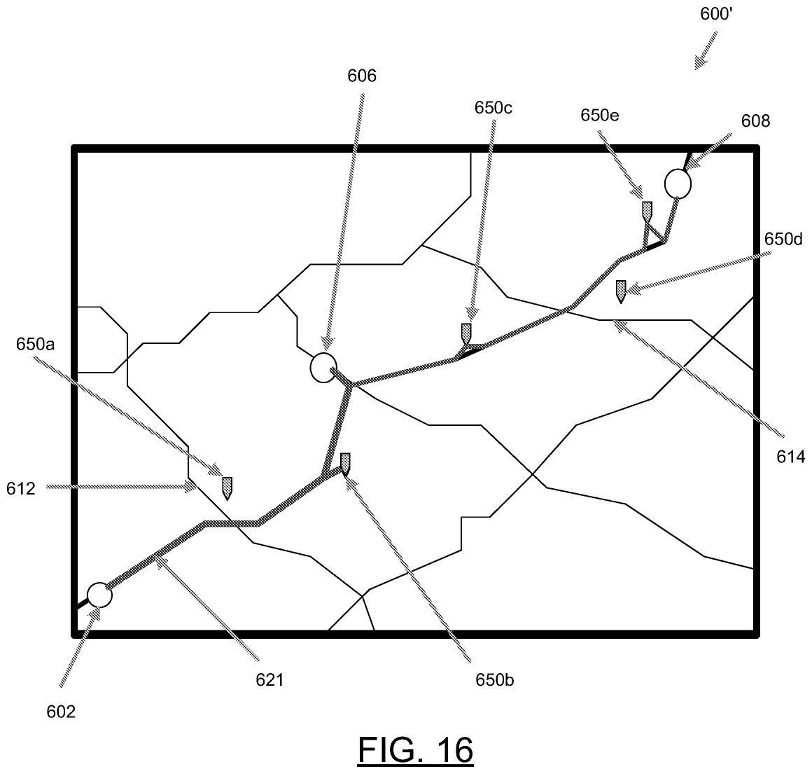

In some cases, there may be no charge device available at the final destination. This may be due, for example, to the final destination not having power (e.g., a campground) or the user being unable to use a charge device (e.g., a rental house, apartment complex, etc.) or other reason. There also may be uncertainty about whether there will be an available charge device. Accordingly, the system may be configured to factor that into any recommended/determined route or charge device recommendation/determination. For example, FIG. 16 illustrates a second planned route 621 on map 600′ where the second planned route 621 includes a stop right before the final destination 608 at charge device 650e. For example, while the motor vehicle may otherwise be able to reach the final destination 608 on the current amount of charge in the battery, the system may determine that it would be desirable (or even necessary) to have extra charge remaining in the battery upon arrival at the final destination 608 to enable future trips. In some embodiments, the system may even be able to determine a next available charge device for the motor vehicle leaving from the final destination 608 (e.g., for returning home, traveling to a grocery store, etc.). The system may factor in what would be needed in the charge remaining to reach that next charge device—alleviating concern of the user that they will run out of charge along the entire trip.

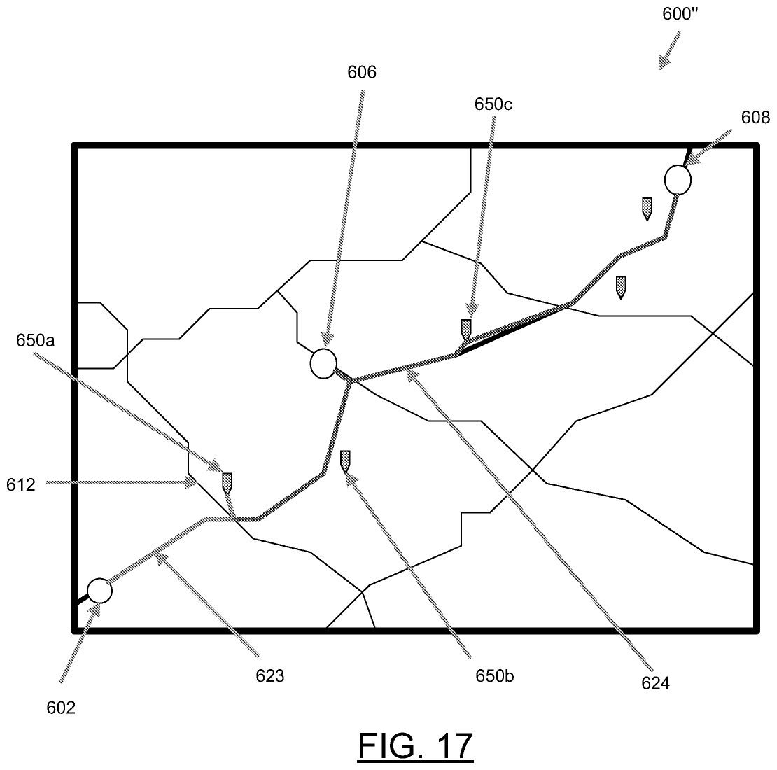

In some embodiments, the system may be configured to dynamically update the planned route (including planned charging stops) as the user travels along, such as using the recommendation/feature module 222. For example, FIG. 17 illustrates the map 600″ where a user has deviated from the first planned route 620 shown in FIG. 15 and gone to charge at charge device 650a (e.g., shown in the first route segment 623 illustrating where the user has already traveled). Depending on various factors (e.g., how much recharge occurred, how much power draw is occurring, what the stop was for, etc.), the system may dynamically update the planned route accordingly. For example, now instead of stopping at charge device 650b, the planned route 624 has the motor vehicle traveling straight to the intermediate destination 606. In this regard, the system may have determined that the stop at charge device 650b is no longer necessary.

### Example System Architecture

FIG. 18 illustrates an example system 100 for providing recommendations and features related to electric vehicle battery charging, in accordance with example embodiments described herein. However, it should be noted that the components, devices, and elements illustrated in and described with respect to FIG. 18 may not be mandatory and, thus, one or more of the components, devices, or elements illustrated may be omitted in certain embodiments. Additionally, some embodiments may include further or different components, devices, or elements beyond those illustrated in and described with respect to FIG. 18.

The system 100 includes a motor vehicle 110 (such as described in various embodiments herein), a remote device 170 (e.g., a user device, smartphone, etc.), service provider(s) 105, server(s)/device(s) 108, and one or more charge devices (e.g., Charge Device 1 150a, Charge Device 2 150b, and Charge Device 3 150c). Such components of the system 100 may be communicatively connected in wired or wireless form, such as via one or more networks (e.g., external network 102).

The motor vehicle 110 may include various systems/devices that may be utilized with various example embodiments of the present invention described herein. For example, the motor vehicle 110 may include a processor 120, a starter battery 119, a user interface 123, a display 122, a memory 121, a position sensor 112, a communication interface 125, an entertainment system (e.g., music system 114), a temperature control/fan system (e.g., A/C/Heater 113), a fuel tank 183 (if the motor vehicle is a hybrid motor vehicle), an engine battery 135, one or more engines 130 (e.g., for electric 132 or fuel 182, such as described herein and as appropriate), and other various systems/devices 129. Notably, less or more components, systems, or devices of the motor vehicle 110 are contemplated by various embodiments described herein.

The processor 120 is configured to perform actions in accordance with one or more example embodiments disclosed herein. In this regard, the processor 120 may be configured to perform and/or control performance of one or more recommendations/features of the system 100 in accordance with various example embodiments. The processor 120 may be configured to perform data processing or other features according to one or more example embodiments described herein.

The processor 120 may be in communication with or otherwise control any number of components or controllers configured to perform various operations consistent with some embodiments of the present invention. For example, processor 120 may be in communication with or otherwise control the starter battery 119, the user interface 123, the display 122, the memory 121, the position sensor 112, the communication interface 125, the entertainment system (e.g., music system 114), the temperature control/fan system (e.g., A/C/Heater 113), the fuel tank 183, the engine battery 135, the one or more engines 130 (e.g., for electrical energy 132 or fuel 182), and the other various systems/devices 129. In some embodiments, the processor 120 may be embodied as a circuit chip (e.g., an integrated circuit chip) configured (e.g., with hardware, software, or a combination of hardware and software) to perform operations described herein. Along these lines, though the illustrated example embodiment of FIG. 18 details a number of different processors and/or components in communication with or otherwise controlled by the processor 120. In some embodiments, the processor 120 may be configured to directly control (or work with any other processor) any operation described herein.

The processor 120 may be embodied in a number of different ways. For example, the processor 120 may be embodied as various processing means such as one or more of a microprocessor or other processing element, a coprocessor, a controller, or various other computing or processing devices including integrated circuits such as, for example, an ASIC (application specific integrated circuit), an FPGA (field programmable gate array), or the like. Although illustrated as a single processor, it will be appreciated that the processor 120 may comprise a plurality of processors. The plurality of processors may be in operative communication with each other and may be collectively configured to perform one or more functionalities of the system 100 as described herein. The plurality of processors may be embodied on a single computing device or distributed across a plurality of computing devices collectively configured to function as the system 100. In some example embodiments, the processor 120 may be configured to execute instructions stored in the memory 121 or otherwise accessible to the processor 120. As such, whether configured by hardware or by a combination of hardware and software, the processor 120 may represent an entity (e.g., physically embodied in circuitry in the form of processing circuitry) capable of performing operations according to embodiments of the present invention while configured accordingly. Thus, for example, when the processor 120 is embodied as an ASIC, FPGA, or the like, the processor 120 may comprise hardware for conducting the operations described herein. Alternatively, as another example, when the processor 120 is embodied as an executor of software instructions, the instructions may specifically configure the processor 120 to perform one or more operations described herein.

In some example embodiments, the memory 121 may include one or more non-transitory memory devices such as, for example, volatile and/or non-volatile memory that may be either fixed or removable. In this regard, the memory 121 may comprise a non-transitory computer-readable storage medium. It will be appreciated that while the memory 121 is illustrated as a single memory, the memory 121 may comprise a plurality of memories. The plurality of memories may be embodied on a single computing device or may be distributed across a plurality of computing devices collectively configured to function as system 100. The memory 121 may be configured to store information, data, applications, instructions and/or the like for enabling the system 100 to carry out various functions in accordance with one or more example embodiments. For example, the memory 121 may be configured to buffer input data for processing by the processor 120. Additionally or alternatively, the memory 121 may be configured to store instructions for execution by the processor 120. As yet another alternative, the memory 121 may include one or more databases that may store a variety of files, contents, or data. Among the contents of the memory 121, applications may be stored for execution by the processor 120 to carry out the functionality associated with each respective application.

The user interface 123 may be in communication with the processor 120 to receive an indication of a user input at the user interface 123 and/or to provide an audible, visual, mechanical, or other output to the user. As such, the user interface 123 may include, for example, a keyboard, a mouse, a joystick, a display (e.g., display 122), a touch screen display, a microphone, a speaker, and/or other input/output mechanisms. As such, the user interface 123 may, in some example embodiments, provide means for user control of system 100 operations and/or the like. In some example embodiments, regardless of implementation, the user interface 123 may provide input and output means to facilitate functions of the system 100 in accordance with one or more example embodiments.

The communication interface 125 may include one or more interface mechanisms for enabling communication with other systems/devices and/or networks. In some cases, the communication interface 125 may be any means such as a device or circuitry embodied in either hardware or a combination of hardware and software that is configured to receive and/or transmit data from/to a network and/or any other device or module in communication with the processor 120. By way of example, the communication interface 125 may be configured to enable the motor vehicle 110 to communicate with the remote device 170 (e.g., directly, such as via Bluetooth, or through an external network 102), and/or other system/devices (e.g., service provider(s) 105, server(s)/device(s) 108, one or more charge devices, etc.). Accordingly, the communication interface 125 may, for example, include supporting hardware and/or software for enabling communications via cable, digital subscriber line (DSL), universal serial bus (USB), Ethernet, or other methods.

In some example embodiments, the processor 120 of the motor vehicle may be embodied as, include, or otherwise control one or more aspects related to the recommendation/feature module 222. In some embodiments, the processor 120 of the motor vehicle may communicate with a remote device (e.g., remote device 170) and provide various functionality and/or data to the remote device 170 for use in conjunction with the recommendation/feature module 222. In this regard, one or more processors within the system 100 may work alone or together to perform functions for the various embodiments described herein. In some embodiments, the processor 120 may gather motor vehicle data for use in various embodiments described herein.

The position sensor 112 may be any sensor configured to determine a current location of the motor vehicle. The position sensor 112 may be a global positioning system (GPS) or other location sensor. In some embodiments, the position sensor 112 may include an orientation sensor, altitude sensor, or other similar sensor.

The entertainment system 114 may be any system or device usable with the motor vehicle to provide entertainment to occupants or other users of the motor vehicle. In some embodiments, the entertainment system 114 may include one or more of music, speakers, satellite music or news, video players, among other things. In some embodiments, the entertainment system 114 draws power from the engine battery 135.

The temperature control/fan system 113 may be any system or device usable with the motor vehicle that provides temperature control and/or air control to the motor vehicle (e.g., heat, A/C, etc.). In some embodiments, the temperature control/fan system 113 draws power from the engine battery 135.

The starter battery 119 may be any power source that stores electrical energy that is usable to aid in starting the engine of the motor vehicle. In some embodiments, the starter battery 119 may be different than the engine battery 135. In some embodiments, the starter battery 119 may be usable for starting the engine 130 that uses fuel 182 such that even if the engine battery 135 is depleted the motor vehicle will be able to operate using fuel. In some embodiments, the engine battery 135 may perform functionality of the starter battery 119.

The engine battery 135 may be any power source and storage device that stores electrical energy that is usable by the engine 130 to cause use of electrical energy to operate the motor vehicle (e.g., to propel the motor vehicle across land). In some embodiments, the engine battery 135 may be used to provide electrical energy to other systems/devices of the motor vehicle as described herein. In some embodiments, the processor 120 is configured to sense a current amount of charge remaining in the engine battery 135 (such as via a current sensor or other battery level sensor).

The fuel tank 183 may be a tank inside the motor vehicle that holds fuel that can be used by the engine 130 (e.g., if the motor vehicle is a fuel consuming vehicle, such as a hybrid motor vehicle). In some embodiments, the processor 120 is configured to sense a current fuel level inside the fuel tank 183.

The engine 130 is a system/device that operates to cause the motor vehicle to propel across land, such as described herein. The engine 130 may be formed only of an electrically powered engine 132 in a fully electric motor vehicle. The engine 130 may also be formed of a single engine 130 can operate using either electrical energy 132 or fuel 182. Alternatively, the engine 130 may be formed of two engines, one the operates using electrical energy 132 and one that operates using fuel 182.

The other system(s)/devices 129 may be any other system or device of the motor vehicle that is usable with various example embodiments described herein.

The remote device 170 may include various systems/devices that may be utilized with various example embodiments of the present invention described herein. For example, the remote device 170 may include a processor 180, a user interface 183, a display 182, a memory 181, a position sensor 172, a communication interface 185, and other various systems/devices 179. Notably, less or more components, systems, or devices of the remote device 170 are contemplated by various embodiments described herein.

The processor 180 is configured to perform actions in accordance with one or more example embodiments disclosed herein. In this regard, the processor 180 may be configured to perform and/or control performance of one or more recommendations/features of the system 100 in accordance with various example embodiments. The processor 180 may be configured to perform data processing or other features according to one or more example embodiments described herein.

The processor 180 may be in communication with or otherwise control any number of components or controllers configured to perform various operations consistent with some embodiments of the present invention. For example, processor 180 may be in communication with or otherwise control the user interface 183, the display 182, the memory 181, the position sensor 172, the communication interface 185, and the other various systems/devices 179. In some embodiments, the processor 180 may be embodied as a circuit chip (e.g., an integrated circuit chip) configured (e.g., with hardware, software, or a combination of hardware and software) to perform operations described herein. Along these lines, though the illustrated example embodiment of FIG. 18 details a number of different processors and/or components in communication with or otherwise controlled by the processor 180. In some embodiments, the processor 180 may be configured to directly control (or work with any other processor) any operation described herein.

The processor 180 may be embodied in a number of different ways. For example, the processor 180 may be embodied as various processing means such as one or more of a microprocessor or other processing element, a coprocessor, a controller, or various other computing or processing devices including integrated circuits such as, for example, an ASIC (application specific integrated circuit), an FPGA (field programmable gate array), or the like. Although illustrated as a single processor, it will be appreciated that the processor 180 may comprise a plurality of processors. The plurality of processors may be in operative communication with each other and may be collectively configured to perform one or more functionalities of the system 100 as described herein. The plurality of processors may be embodied on a single computing device or distributed across a plurality of computing devices collectively configured to function as the system 100. In some example embodiments, the processor 180 may be configured to execute instructions stored in the memory 181 or otherwise accessible to the processor 180. As such, whether configured by hardware or by a combination of hardware and software, the processor 180 may represent an entity (e.g., physically embodied in circuitry in the form of processing circuitry) capable of performing operations according to embodiments of the present invention while configured accordingly. Thus, for example, when the processor 180 is embodied as an ASIC, FPGA, or the like, the processor 180 may comprise hardware for conducting the operations described herein. Alternatively, as another example, when the processor 180 is embodied as an executor of software instructions, the instructions may specifically configure the processor 180 to perform one or more operations described herein.

In some example embodiments, the memory 181 may include one or more non-transitory memory devices such as, for example, volatile and/or non-volatile memory that may be either fixed or removable. In this regard, the memory 181 may comprise a non-transitory computer-readable storage medium. It will be appreciated that while the memory 181 is illustrated as a single memory, the memory 181 may comprise a plurality of memories. The plurality of memories may be embodied on a single computing device or may be distributed across a plurality of computing devices collectively configured to function as system 100. The memory 181 may be configured to store information, data, applications, instructions and/or the like for enabling the system 100 to carry out various functions in accordance with one or more example embodiments. For example, the memory 181 may be configured to buffer input data for processing by the processor 180. Additionally or alternatively, the memory 181 may be configured to store instructions for execution by the processor 180. As yet another alternative, the memory 181 may include one or more databases that may store a variety of files, contents, or data. Among the contents of the memory 181, applications may be stored for execution by the processor 180 to carry out the functionality associated with each respective application.

The user interface 183 may be in communication with the processor 180 to receive an indication of a user input at the user interface 183 and/or to provide an audible, visual, mechanical, or other output to the user. As such, the user interface 183 may include, for example, a keyboard, a mouse, a joystick, a display (e.g., display 182), a touch screen display, a microphone, a speaker, and/or other input/output mechanisms. As such, the user interface 183 may, in some example embodiments, provide means for user control of system 100 operations and/or the like. In some example embodiments, regardless of implementation, the user interface 183 may provide input and output means to facilitate functions of the system 100 in accordance with one or more example embodiments.

The communication interface 185 may include one or more interface mechanisms for enabling communication with other systems/devices and/or networks. In some cases, the communication interface 185 may be any means such as a device or circuitry embodied in either hardware or a combination of hardware and software that is configured to receive and/or transmit data from/to a network and/or any other device or module in communication with the processor 180. By way of example, the communication interface 185 may be configured to enable the remote device 170 to communicate with the motor vehicle 110 (e.g., directly, such as via Bluetooth, or through an external network 102), and/or other system/devices (e.g., service provider(s) 105, server(s)/device(s) 108, one or more charge devices, etc.). Accordingly, the communication interface 185 may, for example, include supporting hardware and/or software for enabling communications via cable, digital subscriber line (DSL), universal serial bus (USB), Ethernet, or other methods.

In some example embodiments, the processor 180 of the remote device 170 may be embodied as, include, or otherwise control one or more aspects related to the recommendation/feature module 222. In some embodiments, the processor 180 of the remote device 170 may communicate with the motor vehicle 110 and provide various functionality and/or data to the motor vehicle 110 for use in conjunction with the recommendation/feature module 222. In this regard, one or more processors within the system 100 may work alone or together to perform functions for the various embodiments described herein. In some embodiments, the processor 180 may gather user data (e.g., user preference data) for use in various embodiments described herein.

The position sensor 172 may be any sensor configured to determine a current location of the remote device 170. The position sensor 172 may be a global positioning system (GPS) or other location sensor. In some embodiments, the position sensor 172 may include an orientation sensor, altitude sensor, or other similar sensor.

The other system(s)/devices 179 may be any other system or device of the remote device 170 that is usable with various example embodiments described herein, such as wind sensors, load/capacity sensors (e.g., for the motor vehicle), etc.

The service provider(s) 105 may be any system, device, or entity that provides a service or other offering, such as usable with any example embodiments described herein. In some embodiments, the service provider(s) 105 have their own processors, communication interfaces, and modules to perform various functionality usable with various example embodiments described herein.

The server(s)/device(s) 108 may be any system or device that provides data and/or processing usable with any example embodiments described herein. In some embodiments, the server(s)/device(s) 108 have their own processors, communication interfaces, and modules to perform various functionality usable with various example embodiments described herein.

The one or more charge devices (e.g., Charge Device 1 150a, Charge Device 2 150b, Charge Device 3 150c, etc.) may be any system or device that provides the ability to charge an engine battery (e.g., engine battery 135). Various example charge devices are further described herein in various embodiments. In some embodiments, the charge device may include their own processors, communication interfaces, and modules to perform various functionality usable with various example embodiments described herein.

### Example Flowchart(s)

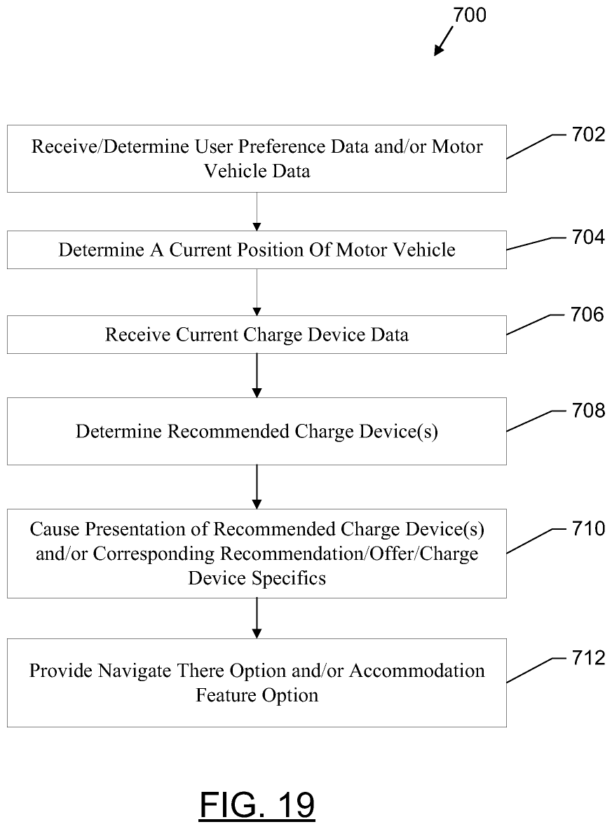

FIGS. 19-22 illustrate various flowcharts of example methods that may be utilized by various example embodiments described herein. Such methods may utilize one or more components of the system 100, such as described above with respect to FIG. 18, or any other system or device described herein. Although the flowcharts include sequence of operations, unless otherwise specified, the order of the operations is not meant to be limited as shown, as some operations may be performed in a different order and/or simultaneously. Further, some operations may be optional and/or some operations are described in other parts of the Detailed Description and Summary Section but may not be specifically included in the flowcharts.

FIG. 19 illustrates a flowchart of an example method 700 for recommending one or more charge devices, in accordance with some example embodiments described herein. At operation 702, the method includes receiving and/or determining user preference data and/or motor vehicle data. At operation 704, the method includes determining a current position (e.g., current location) of the motor vehicle. At operation 706, the method includes receiving current charge device data. At operation 708, the method includes determining one or more recommended charge devices for charging a battery of the motor vehicle, such as based on the charge device data, user preference data, current motor vehicle data, and/or other data. At operation 710, the method includes causing presentation of the one or more recommended charge devices and/or a corresponding information, recommendation, and/or feature (e.g., an offer or promotion) for the charge device(s). At operation 712, the method includes providing a selectable option to navigate to a selected and/or recommended charge device or to utilize an accommodation feature option (e.g., reserving a table at a restaurant).

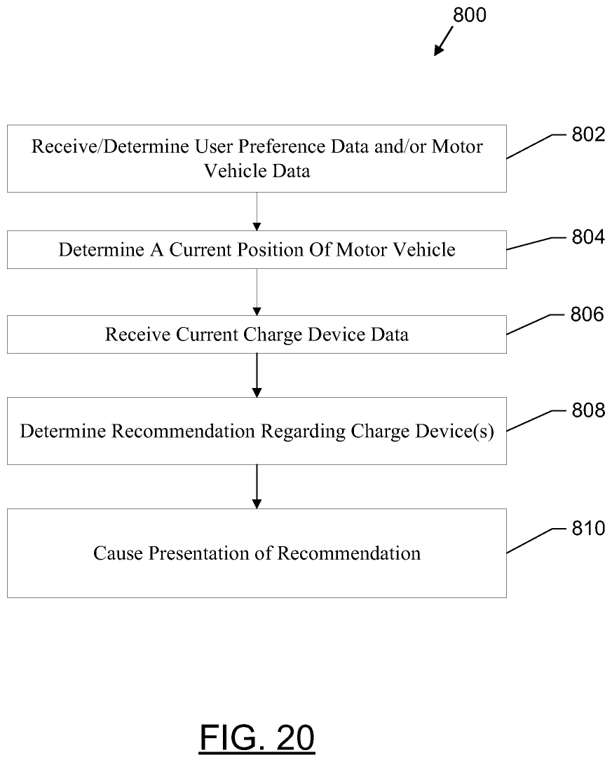

FIG. 20 illustrates a flowchart of an example method 800 for providing a recommendation regarding one or more charge devices, in accordance with some example embodiments described herein. At operation 802, the method includes receiving and/or determining user preference data and/or motor vehicle data. At operation 804, the method includes determining a current position (e.g., current location) of the motor vehicle. At operation 806, the method includes receiving current charge device data. At operation 808, the method includes determining one or more recommendations regarding a charge device, such as based on the charge device data, user preference data, current motor vehicle data, and/or other data. At operation 810, the method includes causing presentation of the one or more recommendations, such as along with information regarding the corresponding charge device.

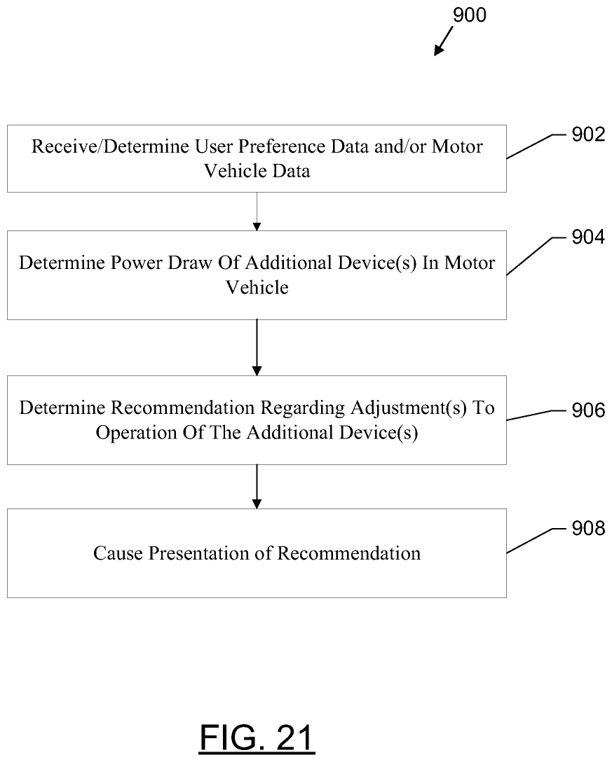

FIG. 21 illustrates a flowchart of an example method 900 for providing a recommendation regarding usage of one or more additional devices, in accordance with some example embodiments described herein. At operation 902, the method includes receiving and/or determining user preference data and/or motor vehicle data. At operation 904, the method includes determining power draw for one or more additional devices in the motor vehicle from the engine battery. At operation 906, the method includes determining one or more recommendations regarding adjustment of operation of the one or more additional devices, such as based on the charge device data, user preference data, current motor vehicle data, and/or other data. At operation 908, the method includes causing presentation of the one or more recommendations.

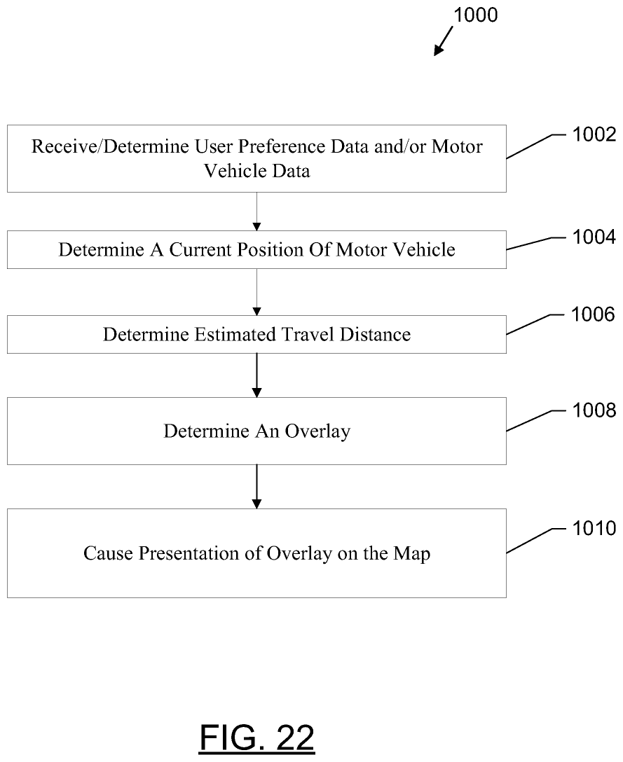

FIG. 22 illustrates a flowchart of an example method 1000 for providing an overlay for a map illustrating an estimated travel distance range for a motor vehicle, in accordance with some example embodiments described herein. At operation 1002, the method includes receiving and/or determining user preference data and/or motor vehicle data. At operation 1004, the method includes determining a current position (e.g., current location) of the motor vehicle. At operation 1006, the method includes determining an estimated travel distance range remaining, such as based on user preference data, current motor vehicle data, and/or other data. At operation 1008, the method includes determining an overlay for presenting on a map to visually indicate reachable and unreachable locations on the map based on the estimated travel distance range remaining. At operation 1010, the method includes causing presentation of the overlay on the map.

FIGS. 19-22 illustrate flowcharts of a system, method, and computer program product according to some example embodiments. It will be understood that each block of the flowcharts, and combinations of blocks in the flowcharts, may be implemented by various means, such as hardware and/or a computer program product comprising one or more computer-readable mediums having computer readable program instructions stored thereon. For example, one or more of the procedures described herein may be embodied by computer program instructions of a computer program product. In this regard, the computer program product(s) which embody the procedures described herein may comprise one or more memory devices of a computing device (for example, memory) storing instructions executable by a processor in the computing device (for example, by the processor). In some example embodiments, the computer program instructions of the computer program product(s) which embody the procedures described above may be stored by memory of a plurality of computing devices. As will be appreciated, any such computer program product may be loaded onto a computer or other programmable apparatus, such that the computer program product including the instructions which execute on the computer or other programmable apparatus creates means for implementing the functions specified in the flowchart block(s). Further, the computer program product may comprise one or more computer-readable memories on which the computer program instructions may be stored such that the one or more computer-readable memories can direct a computer or other programmable apparatus to function in a particular manner, such that the computer program product may comprise an article of manufacture which implements the function specified in the flowchart block(s). The computer program instructions of one or more computer program products may also be loaded onto a computer or other programmable apparatus to cause a series of operations to be performed on the computer or other programmable apparatus to produce a computer-implemented process such that the instructions which execute on the computer or other programmable apparatus implement the functions specified in the flowchart block(s).

Accordingly, blocks of the flowcharts support combinations of means for performing the specified functions and combinations of operations for performing the specified functions. It will also be understood that one or more blocks of the flowcharts, and combinations of blocks in the flowcharts, can be implemented by special purpose hardware-based computer systems which perform the specified functions, or combinations of special purpose hardware and computer instructions.

### CONCLUSION

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

1.-118. (canceled)

119. A system for indicating an estimated travel distance for a motor vehicle based on a current amount of charge of a battery used to provide electrical energy for an electric powered engine of the motor vehicle, the system comprising:
a motor vehicle comprising:
an engine for propelling the motor vehicle on land using electrical energy,
a battery for providing the electrical energy to the engine, wherein the battery is rechargeable,
a battery sensor configured to sense an amount of charge remaining in the battery; and
memory;
a processor configured, when executing computer program product code stored in the memory, to:
receive current motor vehicle data, wherein the current motor vehicle data includes at least charge remaining data, wherein the charge remaining data corresponds to a current amount of charge remaining in the battery;
determine a current location of the motor vehicle;
cause display of a map including the current location of the motor vehicle;
determine an estimated travel distance for the motor vehicle based on the current amount of charge remaining in the battery;
determine an overlay for the map indicating one or more locations on the map where the motor vehicle is able to travel to based on the estimated travel distance and one or more locations on the map where the motor vehicle is unable to travel based on the estimated travel distance; and
cause display of the overlay on the map to thereby indicate the one or more locations on the map where the motor vehicle is able to travel to based on the estimated travel distance and the one or more locations on the map where the motor vehicle is unable to travel based on the estimated travel distance.

120. The system of claim 119, wherein display of the overlay applies shading to the one or more locations on the map where the motor vehicle is unable to travel based on the estimated travel distance.

121. The system of claim 120, wherein the shading is applied outside of buildings or map features that are at positions along the road that are reachable by the motor vehicle.

122. The system of claim 119, wherein the processor is further configured to:
determine current traffic or construction data corresponding with one or more routes that the motor vehicle could travel along; and
determine the overlay based on the current traffic or construction data such that the one or more locations on the map where the motor vehicle is unable to travel is updated based on the traffic or construction data.

123. The system of claim 119, wherein the processor is further configured to:
determine an adjustment in usage of the at least one device of the motor vehicle that results in decreasing the amount of charge of the battery being used by the at least one device;
determine a second estimated travel distance for the motor vehicle based on the current amount of charge remaining in the battery with the determined adjustment in usage of the at least one device of the motor vehicle; and
cause the overlay to be updated based on the second estimated travel distance.

124. The system of claim 119, wherein the motor vehicle further comprises a second engine for propelling the motor vehicle on land using gas or diesel, wherein the motor vehicle further includes a fuel gauge configured to sense the amount of gas or diesel remaining in a fuel tank of the motor vehicle, wherein the current motor vehicle data further includes at least fuel remaining data, wherein the fuel remaining data corresponds to a current amount of fuel remaining in the fuel tank of the motor vehicle, and wherein the processor is further configured to:
determine, based on the current motor vehicle data, the overlay to include an indication of one or more locations where the motor vehicle is able to reach using the second engine once the current amount of charge remaining in the battery is depleted.

125. The system of claim 124, wherein the overlay includes a first shading showing the one or more locations on the map where the motor vehicle is able to travel to based on the estimated travel distance corresponding to the current amount of charge remaining in the battery and a second shading showing the one or more locations where the motor vehicle is able to reach using the second engine once the current amount of charge remaining in the battery is depleted, wherein the first shading is different than the second shading.

126. The system of claim 119, wherein the processor is further configured to:
dynamically update the overlay as the motor vehicle travels.

127. A method for indicating an estimated travel distance for a motor vehicle based on a current amount of charge of a battery used to provide electrical energy for an electric powered engine of the motor vehicle, the method comprising:
receiving current motor vehicle data, wherein the current motor vehicle data includes at least charge remaining data, wherein the charge remaining data corresponds to a current amount of charge remaining in a battery of the motor vehicle sensed by a battery sensor of the motor vehicle, wherein the battery is rechargeable and provides electrical energy to an engine of the motor vehicle, wherein the engine propels the motor vehicle on land using the electrical energy;
determining a current location of the motor vehicle;
causing display of a map including the current location of the motor vehicle;
determining an estimated travel distance for the motor vehicle based on the current amount of charge remaining in the battery;
determining an overlay for the map indicating one or more locations on the map where the motor vehicle is able to travel to based on the estimated travel distance and one or more locations on the map where the motor vehicle is unable to travel based on the estimated travel distance; and
causing display of the overlay on the map to thereby indicate the one or more locations on the map where the motor vehicle is able to travel to based on the estimated travel distance and the one or more locations on the map where the motor vehicle is unable to travel based on the estimated travel distance.

128. The method of claim 127, wherein display of the overlay applies shading to the one or more locations on the map where the motor vehicle is unable to travel based on the estimated travel distance.

129. The method of claim 128, wherein the shading is applied outside of buildings or map features that are at positions along the road that are reachable by the motor vehicle.

130. The method of claim 127 further comprising:
determining current traffic or construction data corresponding with one or more routes that the motor vehicle could travel along; and
determining the overlay based on the current traffic or construction data such that the one or more locations on the map where the motor vehicle is unable to travel is updated based on the traffic or construction data.

131. The method of claim 127 further comprising:
determining an adjustment in usage of the at least one device of the motor vehicle that results in decreasing the amount of charge of the battery being used by the at least one device;
determining a second estimated travel distance for the motor vehicle based on the current amount of charge remaining in the battery with the determined adjustment in usage of the at least one device of the motor vehicle; and
causing the overlay to be updated based on the second estimated travel distance.

132. The method of claim 127, wherein the motor vehicle further comprises a second engine for propelling the motor vehicle on land using gas or diesel, wherein the motor vehicle further includes a fuel gauge configured to sense the amount of gas or diesel remaining in a fuel tank of the motor vehicle, wherein the current motor vehicle data further includes at least fuel remaining data, wherein the fuel remaining data corresponds to a current amount of fuel remaining in the fuel tank of the motor vehicle, and wherein method further comprises:
determining, based on the current motor vehicle data, the overlay to include an indication of one or more locations where the motor vehicle is able to reach using the second engine once the current amount of charge remaining in the battery is depleted.

133. The method of claim 132, wherein the overlay includes a first shading showing the one or more locations on the map where the motor vehicle is able to travel to based on the estimated travel distance corresponding to the current amount of charge remaining in the battery and a second shading showing the one or more locations where the motor vehicle is able to reach using the second engine once the current amount of charge remaining in the battery is depleted, wherein the first shading is different than the second shading.

134. The method of claim 127 further comprising:
dynamically updating the overlay as the motor vehicle travels.

135.-140. (canceled)

141. The system of claim 123, wherein the processor is further configured to:
cause a notification to be provided to a user indicating how to adjust the at least one device of the motor vehicle so as to achieve the second estimated travel distance for the motor vehicle.

142. The method of claim 131 further comprising:
causing a notification to be provided to a user indicating how to adjust the at least one device of the motor vehicle so as to achieve the second estimated travel distance for the motor vehicle.

143. Computer program product comprising a non-transitory computer readable medium having program code stored thereon, the program code being configured, when said program product is run by a processor, to:
receive current motor vehicle data, wherein the current motor vehicle data includes at least charge remaining data, wherein the charge remaining data corresponds to a current amount of charge remaining in a battery of the motor vehicle sensed by a battery sensor of the motor vehicle, wherein the battery is rechargeable and provides electrical energy to an engine of the motor vehicle, wherein the engine propels the motor vehicle on land using the electrical energy;
determine a current location of the motor vehicle;
cause display of a map including the current location of the motor vehicle;
determine an estimated travel distance for the motor vehicle based on the current amount of charge remaining in the battery;
determine an overlay for the map indicating one or more locations on the map where the motor vehicle is able to travel to based on the estimated travel distance and one or more locations on the map where the motor vehicle is unable to travel based on the estimated travel distance; and
cause display of the overlay on the map to thereby indicate the one or more locations on the map where the motor vehicle is able to travel to based on the estimated travel distance and the one or more locations on the map where the motor vehicle is unable to travel based on the estimated travel distance.
